(19) United States
(12) Patent Application Publication
(10) Pub. No.: US 2007/0033828 A1
(43) Pub. Date: Feb. 15, 2007

(54) Method and apparatus for roasting coffee beans by means of concentrated solar thermal energy

(75) Inventors: David Hartkop, Central Point, OR (US); Michael Hartkop, Bend, OR (US)

Correspondence Address: KEUSEY, TUTUNJIAN & BITETTO, P.C., 20 CROSSWAYS PARK NORTH, SUITE 210, WOODBURY, NY, 11797, US

(73) Assignee: Solar Roast Coffee LLC

(21) Appl. No.: 11/500,658

(22) Filed: Aug. 8, 2006

Related U.S. Application Data
(60) Provisional application No. 60/706,584, filed on Aug. 9, 2005.

(51) Int. Cl. F26B 3/34; F26B 3/00

(52) U.S. Cl. 34/443; 34/245

(57) ABSTRACT

A novel combination of technologies from the fields of coffee roasting and solar-thermal energy collection enables the roasting of coffee beans by means of available solar energy with maximized efficiency. A solar receiving plate is provided configured to receive and convert solar radiation to thermal energy for heating a volume of air. A roasting chamber is provided configured for receiving and circulating the heated air from the solar plate. At least one valve is provided configured to be in at least one of a closed position and an open position for controlling at least one of air inflow and outflow into at least one of said solar receiving plate and said roasting chamber.

The present application claims priority from U.S. Provisional Application Ser. No. 60/706,584 entitled, “METHOD AND APPARATUS FOR ROASTING COFFEE BEANS BY MEANS OF CONCENTRATED SOLAR THERMAL ENERGY,” filed on Aug. 9, 2005.

### BACKGROUND OF THE INVENTION

1. Technical Field

This invention relates to the field of coffee roasting, wherein a quantity of dry green coffee beans is heated under carefully controlled conditions in order to facilitate the reduction of moisture, the caramelization of natural sugars, and the release of desirable flavor-rich oils. The invention also relates to the field of solar thermal energy, which involves the collection, concentration, and utilization of solar radiation by means of a large mechanically tracked reflector system.

2. Description of Related Art

Coffee Roasting:

The history of coffee spans over one thousand years of human history and is as much technological as it is cultural. This brief background focuses on innovative progress in three categories: The fuel utilized in the roasting process, the ability to monitor and maintain consistency during the roasting process, and the ability to yield roasted coffee in substantial quantities.

The earliest known cultivation and preparation of coffee dates back to 1000 A.D. in Arabia. The green undried beans, derived from the Coffea Arabica shrub, were directly boiled to produce a strong caffeinated drink named “qahwa.” Translated from Arabic, qahwa literally means, “That which prevents sleep.” The only implements involved were simple metal pots supported over wood fires.

By the mid 16th century, coffee had spread throughout most of the Middle East. A newer preparation technique involved roasting beans in a pan above an open fire and stirring with a flattened implement. The beans were then ground with mortar and pestle, boiled, and strained to make unsweetened coffee. This method allowed for a few ounces of coffee to be produced at a time, and remained nearly unchanged through the 17th and 18th centuries.

During the 19th century, coffee roasting was mechanized. The traditional open and covered roasting pans were replaced by the predecessors of the drum roaster. These devices were typically cylindrical or spherical tumblers that were turned by hand over a fire. This advance greatly improved the evenness of the coffee roast, but the early roasters were limited in capacity to 8 to 10 ounces.

In 1877, German engineer Theodor von Gimborn was granted German Patent No. 100 for his Emmerich Ball Roaster. It consisted of a spherical ball that sat upright over a flame and was turned by hand. After several minutes of heating, the ball was opened and roasted coffee poured out. It was the predecessor to all modern PROBAT roasters.

In the early 20th century, the availability of electricity and powerful blower fans enabled the modern air-roaster. These devices, heated by natural gas, roast coffee with a stream of hot air in an arrangement similar to a popcorn air popper. This method enables careful temperature control based on air heating rather than drum temperature.

A modern extension of this technology is the continuous roaster, which allows beans to move through the machine in an uninterrupted stream, providing continuous coffee outflow in industrial quantities.

This approach has been further modified to include electrical heating elements in place of combustion heaters.

Most modern innovations in coffee roasting are improvements to instrumentation and control systems that further improve the reliability and reproducibility of roasts, while at the same time increasing industrial production volume. Nearly all-commercial roasters rely on natural gas or propane as an energy source because electrical heating generally has too high an energy cost.

Concentration of Solar Thermal Energy:

Solar radiation, as an energy source, is typically rated at having an energy concentration of 1.0 kilowatts per square meter, as measured such that the light rays are normal to the surface of measurement. In practical terms, this is sufficient for direct use cooking, as has been done in various forms for hundreds of years using simple mirror-type boxes. A mirror box is typically a closed container having a window that can admit sunlight, mirrored internal walls that reflect the sunlight onto a blackened photo-absorbent cooking vessel. This system typically directs solar radiation to its target with a concentration ratio of less than 5:1 (meaning less than five times the normal solar radiation of direct sunlight). Variations on mirror box technology are currently being explored as cost effective alternatives to wood-burning stoves in several developing countries. They are typically small-scale units, capable of cooking food enough for a single family meal over a period of several hours.

The earliest historical accounts of the concentration and utilization of solar thermal energy are linked to the Greek mathematician, philosopher, and inventor, Archimedes of Syracuse (287-212 BC). According to all accounts, Archimedes assisted in the defeat of a Roman siege by directing Greek soldiers to polish and aim bronze shields at their assailants' ships. The shields, polished to mirrors, effectively directed and concentrated sunlight over distance to the effect that it set fire to several Roman ships and demoralized the attacking force.

The first serious research involving collection schemes of higher concentration ratios was done by French mathematician Auguste Mouchout, at the Lyce de Tours beginning in 1860. Rather than using a simple silver-lined box, he opted for an enlarged conical reflector, described as an inverted lampshade coated on the inside with silver leaf. The reflector focused solar energy onto a blackened cylindrical water boiler, and could be pivoted in two axes in order to align to the sun. He successfully demonstrated the ability to boil water and drive a steam engine, which could then drive an ammonia-based refrigerator to make ice. His reflector system boasted a concentration ratio of roughly 100:1.

In 1878, the English deputy registrar for Bombay India, William Adams, expanded upon the design. He replaced the large and delicate conical reflector with a more robust and easily constructed frame that held multiple flat mirrors that were individually set to a focal point. His original designs included a simple flat rack that was aimed at the sun in two axes, as well as a larger system of mirrors that rolled around a semicircular track to face the sun. The focus of his mirrors was set on an elevated water boiler that generated steam, which drove a steam engine that could pump water in the parched Indian fields where coal was scarce. His inventions were the direct predecessors to the modern Power Tower approach. Because Adams design was based on the convergence of multiple flat reflectors, it was easy to calculate the concentration of various reflectors. His devices as well as modern power towers boast concentration ratios of thousands to one.

U.S. Marine engineer John Ericsson began his work with solar concentrators in 1870. He opted for a curved rather than a multi-mirror type reflector system, and eventually invented the parabolic trough concentrator. The trough-type concentrator focuses sunlight to a linear focus rather than to a point. Ericsson placed a pipe at the focus of his trough, heating water to produce steam. Many modern solar thermal power plants utilize this same design to heat oil, which then transfers heat to a boiler to produce steam for a turbine. Parabolic trough type reflectors typically have concentration ratios in the range of 15:1 to 30:1, and usually do not exceed 100:1.

In 1903, a businessman named Aubrey Eneas built a demonstration solar thermal system in an ostrich farm in Pasadena, Calif. His system included a 30-foot diameter solar reflector made up of some 1700 individual mirrors, and drove a steam engine to pump over 1400 gallons of water per minute. His machine was used to successfully irrigate the farm, but the system was not robust enough to be commercially successful.

Frank Shuman of Tacony, Pa. founded the Sun Power Corporation in 1910. He incorporated many solar collection concepts from previous solar power devices into his system, including the concept of a curved parabolic reflector, an insulated pipe-like collector, and a two-axis tracking system. His final system was demonstrated outside Cairo, Egypt in 1912 and was capable of driving a steam engine that could pump more than 4000 gallons of water per minute. Political upheaval in the region prevented his systems to be fully implemented, however, and he was forced to prematurely end his research.

Modern large-scale solar concentrating systems typically use either the parabolic trough system pioneered by Ericsson, the multi-mirror power-tower approach invented by Adams, or the parabolic dish system described by Shuman.

The Solar I experimental solar power plant, later retrofitted to be Solar II, was built in Mojave, Calif. by the US Department of Energy and a consortium of industrial partners, and operated from the early 1980's to 1999. Both Solar I and Solar II produced up to 10 Mw of electrical power, and demonstrated the economic feasibility of the power tower approach, when implemented on a large scale.

Currently, nine power plants in Southern California employ the parabolic trough method to produce electrical power from concentrated solar thermal energy. Each of these plants typically produces around 80 Mw of power, and all are hybrid systems, operating on conventional fuel after dark and on cloudy days.

There is currently much research in smaller dish-based systems. In these systems, solar energy is reflected by one or several combined parabolic mirrors onto the absorber plate of a heat-engine, which converts thermal energy into mechanical energy to drive an electrical generator. The mirrors are often times formed from thin sheets of reflective Mylar stretched over concave structural surfaces. In some cases, a concave mirror can be formed by stretching reflective Mylar over one end of shallow circular airtight cavity, and then partially evacuating the cavity, causing the Mylar to uniformly deform inward due to air pressure distribution. Parabolic reflectors of this type can deliver concentrations of hundreds up to thousands to one. These smaller dish-based systems are seen as potential generators for a distributed solar power system, with many ganged together to produce electrical energy. Such systems have yet to be implemented in any large-scale program.

Today, there are a number of commercially available solar oven products intended for the heating of food. These generally employ a metallic or Mylar coated parabolic dish that is aligned to the sun. Food items to be heated are placed in a blackened metal vessel and placed centrally, at the focus of the dish.

### SUMMARY OF THE INVENTION

A novel combination of technologies from the fields of coffee roasting and solar-thermal energy collection enables the roasting of coffee beans by means of available solar energy. A specially adapted coffee roaster is placed at the focus of a solar concentrating system, where radiation is converted into thermal energy. Heat is transferred into green coffee beans within the roasting device. Controlled heating of beans causes the release of moisture, caramelization of sugars, and releases desirable natural oils. Various embodiments are described, and may be applied to coffee production at different scales of output.

The various embodiments of the invention exhibit a novel union between technology in the field of coffee roasting and the field of solar-thermal concentration. Currently, coffee is commercially roasted using either of two main roaster types:

1. The fluid-bed air roasting type, which suspends and heats beans in a continuous upward-flowing stream of hot air.

2. The drum-type roaster, which tumbles beans within a rotating perforated cylinder.

Nearly all commercial systems produce thermal energy for the roasting process by burning natural gas or propane, though there are small-scale systems that are electrically heated. Typically, very little attempt is made to conserve or reuse the thermal energy produced in these systems, making them inefficient and energy intensive. The body of this document describes methods for building roasters that receive concentrated sunlight as their primary source of thermal energy. Methods are also described for maximizing the efficiency of the roaster by means of adequate thermal insulation, proximity of the solar-thermal collector component to the roasting chamber, and by recycling already heated air through the roaster. Though the two common roaster types are described, both embodiments rely on identical innovative improvements in energy usage, and can thusly be considered embodiments of the same invention. The choice of roaster type implemented in a given embodiment is based largely on the personal taste of the coffee roaster, and so roaster type should be considered interchangeable in the context of the exemplary concentrator architectures discussed in below.

The present invention also involves novel applications of solar concentrating technology for the purposes of coffee roasting. For exemplary purposes, discussed are solar concentration systems of three distinct scales, intended for solar roasters of three different scales of output. Small-scale solar roasters (e.g., 1-5 lb/roast) are best embodied through use of a fixed reflector topology, in which a small roaster head is placed in a fixed relationship with respect to a concentrating reflector. The reflector/roaster system is then tracked to the sun in two axes, either manually or by means of a motorized tracking system. The system requires precise initial weight balancing, but is robust, maintains excellent focus, and is simple enough for one person to operate. It is, however, somewhat limited in scale because the roaster head must be raised on an extended arm as the sun reaches mid-day. Since the roaster head must be reachable by the operator at all times during the roasting process, scaling up the dimensions of the design can quickly raise the roaster head to an unsafe elevation.

For medium/large scale solar roasters (e.g., 5-100 lb/roast), a center-pivot mirror array topology is preferable. In this configuration, a reflector and a roaster unit are placed in a fixed relationship with respect to one another, and the system they form rotates about a vertical axis in order to track the sun's azimuth angle. The reflector array consists of multiple mirrors that have been fixed in their horizontal alignment, but can be simultaneously rotated vertically in order to track the sun's zenith angle. This system allows for larger scale roaster and reflector systems to be used because the system remains at ground level and may be made to pivot about a center point on a circular or semicircular track. The system may be scaled up to very large sizes, and the roaster unit will remain accessible to the operator. It also adds a measure of safety in that the mirrors can be rotated upwards into and ‘off’ position, quickly removing the roaster unit from solar exposure. Systems of this type track the sun using motorized actuators and solar position sensors.

For very high volume coffee roasting systems (e.g., 100+lb/roast), a third configuration adapts the ‘power tower’ approach for the purposes of coffee roasting. In this system, a reflector array consisting of multiple mirrors is made to focus reflected sunlight onto a receiver target set atop a tower, which extends upwards from the vicinity of the actual roasting unit. Mirrors of the array may be set atop individual heliostatic tracking motors, or may be connected to a large mechanical framework. Mirrors in the array each individually track the position of the sun in 2-axes throughout the day, maintaining focus on the target. Air is heated to high temperature as it is blown through the receiver target, and is then piped into the coffee roaster unit. Though this system is the most complex to implement, an added benefit is that it can be scaled to virtually any desired output because the roaster system does not need to move or pivot in any direction. Further, heated air from one collector tower may be distributed to multiple roaster systems for simultaneous roasting of multiple different coffee types.

According to an aspect of the present invention, a system for roasting coffee beans is provided comprising a solar receiving plate configured to receive and convert solar radiation to thermal energy for heating a volume of air, a roasting chamber configured for receiving and circulating the heated air from the solar plate, and at least one valve configured to be in at least one of a closed position and an open position for controlling at least one of air inflow and outflow into at least one of said solar receiving plate and said roasting chamber.

According to another aspect of the present invention, a method for roasting is provided comprising the steps of providing a solar roasting system comprising a solar receiving plate configured to receive and convert solar radiation to thermal energy for heating a volume of air, providing a roasting chamber configured for receiving and circulating the heated air from the solar plate, and providing at least one valve configured to be in at least one of a closed position and an open position for controlling at least one of air inflow and outflow into at least one of said solar receiving plate and said roasting chamber. A solar thermal concentrator is provided configured to collect and focus solar radiation onto the solar receiving plate.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1A shows an exemplary top view of an exemplary internal roasting drum according to an embodiment of the invention;

FIG. 1B depicts an exemplary side view of the internal roasting drum according to an aspect of the present invention;

FIG. 2 shows a cross section of the assembled drum roaster module according to an embodiment of the invention;

FIG. 3A shows a top view of the assembled drum roaster module on a pivotable support mount according to an embodiment of the invention;

FIG. 3B depicts a side view of an exemplary assembled drum roaster module on the pivotable support mount according to an aspect of the present invention;

FIGS. 4A and 4B depict the drum roaster module in various exemplary pivoted positions according to an embodiment of the invention;

FIG. 5A depicts the activity of coffee beans within the internal roasting drum during roasting according to an aspect of the present invention;

FIG. 5B depicts the pouring of roasted beans according to an embodiment of the invention;

FIG. 6A shows a top view of an exemplary full solar roaster arrangement, demonstrating the path taken by rays of sunlight according to an embodiment of the invention;

FIG. 6B shows a side view of an exemplary full solar roaster arrangement, demonstrating the path taken by rays of sunlight according to an embodiment of the invention;

FIGS. 7A, 7B and 7C demonstrate a solar roaster's exemplary vertical tracking of the sun from morning to high noon, respectively, according to an embodiment of the invention;

FIG. 8 illustrates an exemplary hardware mounting scheme used to support and align one of many square mirrors in the solar concentrating array according to an embodiment of the invention;

FIG. 9A illustrates an exemplary mounting of mirrors on vertical rods according to an embodiment of the invention;

FIGS. 9B, 9C and 9D illustrate top, front and side views, respectively, of an exemplary grouping of vertical rods between horizontal support beams according to an embodiment of the invention;

FIG. 10 is an exploded front view of the vertical rods, support beams, and framework for an exemplary solar concentrator according to an embodiment of the invention;

FIG. 11A depicts an exemplary top view of an assembled reflector support frame according to an embodiment of the invention;

FIG. 11B depicts an exemplary front view of an assembled reflector support frame according to an embodiment of the invention;

FIG. 11C depicts an exemplary side view of the assembled reflector support frame according to an embodiment of the invention;

FIG. 12 is an exploded side view of an exemplary main support arm and base according to an embodiment of the invention;

FIGS. 13A, 13B and 13C illustrate exemplary top, side and front views, respectively, of the assembled main support arm and base according to an embodiment of the invention;

FIG. 14 is an orthographic side view of an exemplary assembled solar concentrator, main support arm, and base according to an embodiment of the invention;

FIGS. 15A, 15B, 15C are perspective renderings of the assembled solar roaster system according to an embodiment of the invention;

FIG. 16A demonstrate the function of the position-locking clamp according to an embodiment of the invention;

FIG. 16B demonstrates the function of an exemplary ‘safety strut’ according to an aspect of the present invention;

FIG. 17A provides an enlarged view of the position locking clamp shown in Box “A” of FIG. 16A according to an embodiment of the invention;

FIG. 17B provides a top view of the position locking clamp of FIG. 17A according to an embodiment of the invention;

FIG. 18A, 18B, 18C show exemplary embodiments of solar roasting technology applied at small, medium and large scales of production output, respectively;

FIG. 19A is a system schematic of an exemplary natural gas fluid bed coffee roaster, according to the prior art;

FIG. 19B is a system schematic of an exemplary fluid bed solar coffee roaster, according to an embodiment of the invention;

FIG. 19C is a system schematic of an exemplary electric fluid bed coffee roaster, according to the prior art;

FIG. 19D is a system schematic of an exemplary compact fluid bed solar coffee roaster, according to an embodiment of the invention;

FIG. 20A is a system schematic of an exemplary natural gas fired drum coffee roaster, according to the prior art;

FIG. 20B is a system schematic of an exemplary solar heated drum coffee roaster, according to an embodiment of the invention;

FIG. 20C is a system schematic of an exemplary electric drum coffee roaster, according to the prior art;

FIG. 20D is a system schematic of an exemplary compact solar drum roaster, according to an embodiment of the invention;

FIG. 20E is a system schematic of a second, simplified compact solar drum roaster, according to an embodiment of the invention;

FIG. 21A, illustrates a front view of the door of a drum roaster, according to an embodiment of the invention;

FIG. 21B illustrates a side view of an exemplary roasting chamber of a drum roaster according to an embodiment of the invention;

FIG. 21C illustrates beans in a drum roaster during a roasting process, according to an embodiment of the invention;

FIG. 21D illustrates an exemplary removal process of beans in a drum roaster, according to an embodiment of the invention;

FIG. 22 illustrates an exemplary solar coffee roaster in a fixed-mirror configuration, according to an embodiment of the invention;

FIGS. 23A and 23B illustrate exemplary perspective and side views, respectively, of solar coffee roasters using a curved surface reflector, according to an alternate embodiment of the invention;

FIG. 24 is a system schematic of an exemplary solar coffee roaster using the large scale power-tower configuration, according to an embodiment of the invention;

FIGS. 25A, 25B and 25C illustrate side, front and perspective views, respectively, of a fixed mirror mounting scheme, according to an embodiment of the invention;

FIG. 26 illustrates an exemplary solar coffee roaster in a center-pivot, vertical tracking mirror configuration, according to an embodiment of the invention;

FIGS. 27A, 27B, 27C illustrate top and side views of three different center-pivot configurations, respectively, according to various embodiments of the invention;

FIGS. 28A, 28B and 28C demonstrate the vertical tracking of various angles of sunlight using a solar roaster in a center-pivot, vertical tracking mirror configuration, according to an embodiment of the invention;

FIG. 29A illustrates side, top and front views of a horizontal row of an assembly of flat mirrors according to an embodiment of the invention;

FIGS. 29B and 29C illustrate the assembly of flat mirrors into a vertical tracking mirror array, according to an embodiment of the invention;

FIGS. 30A, 30B and 30C demonstrate the vertical tilting of mirrors in a balanced vertical tracking mirror array with respect to various angles of sunlight, according to an embodiment of the invention; and

FIG. 31 illustrates the horizontal convergence of reflected beams of light as accomplished by a horizontal row of mirrors in a vertical tracking mirror array, according to an embodiment of the invention.

It should be understood that the drawings are for purposes of illustrating the concepts of the invention and are not necessarily the only possible configuration for illustrating the invention.

### DETAILED DESCRIPTION OF PREFERRED EMBODIMENTS

The Solar Coffee Roaster comprises two main subsystems: 1) A coffee roaster module that is capable of receiving concentrated solar radiation as its primary heat source, and 2) A solar concentrator which focuses solar radiation onto the receiver of the coffee roaster module.

I. Coffee Drum Roaster Module

A. Drum Roaster

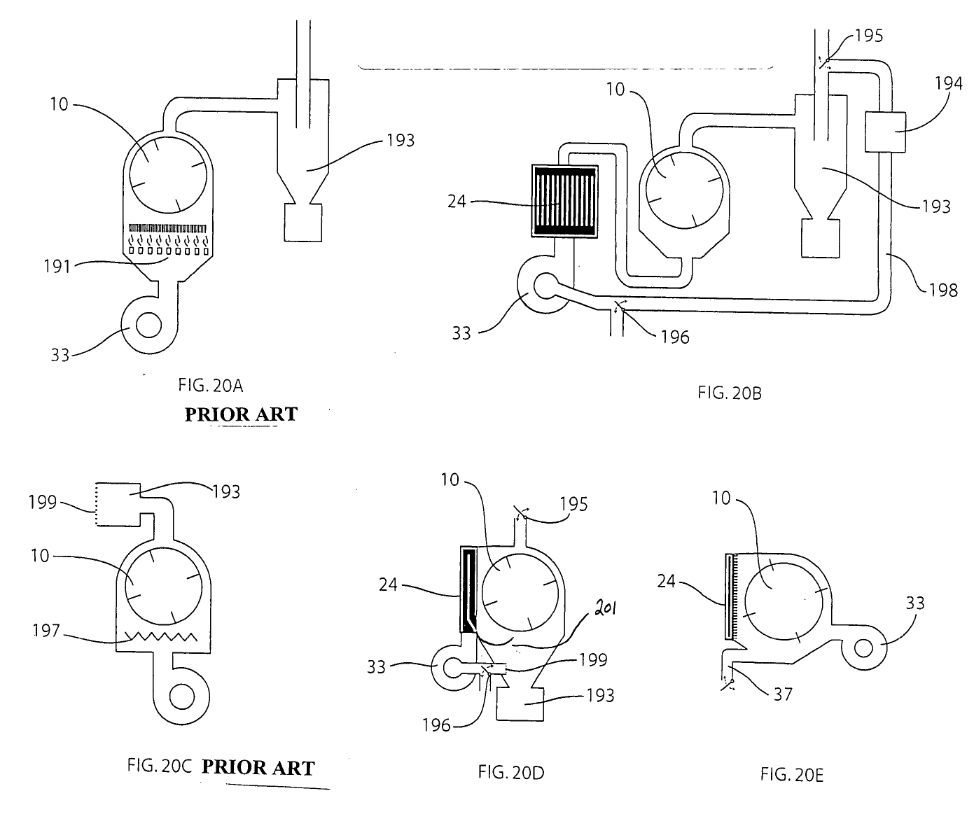

FIG. 20A illustrates the basic system schematic for a standard natural-gas powered drum roaster, according to the prior art. Coffee is placed in a cylindrical drum (10), which is caused to turn by a motor drive system. Air is blown into the system from a fan (33) and is heated by a burner system (191). The heated passes through holes in the drum to heat the beans, causing them to caramelize and to release fragrant oils. The air then passes out of the roasting chamber and into a chaff-collection system (193), where the solid particulate “chaff” cast off the beans during the roasting process is allowed to settle. The remaining smoke and hot air passes out through an exhaust flue.

FIG. 20C illustrates a system schematic for a standard electrically heated drum roaster, according to the prior art. Coffee placed in the cylindrical drum is turned while it is heated by air, which passes over resistive heating coils (197). The heated air circulates over the beans causing them to roast, and then passes out of the roasting chamber into a chaff collection system (193) and out through a wire-mesh filter (199).

1. Drum Roaster Module Embodiment #1, Large Scale Model.

An embodiment of a solar heated drum roaster is shown in system schematic form in FIG. 20B. This embodiment is a medium to large-scale roaster unit that is capable of processing from tens to hundreds of pounds per roast.

Roasting Drum

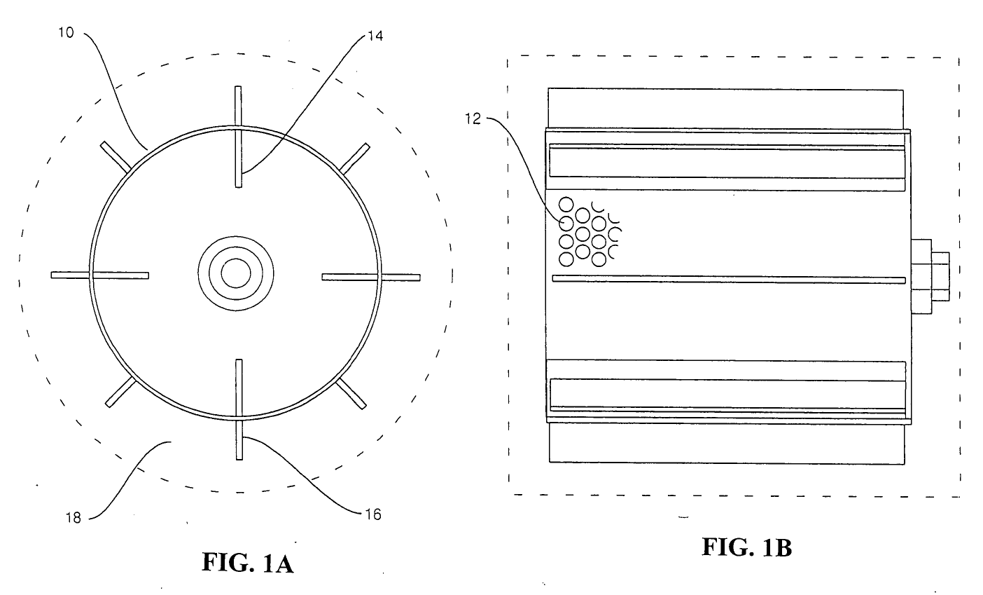

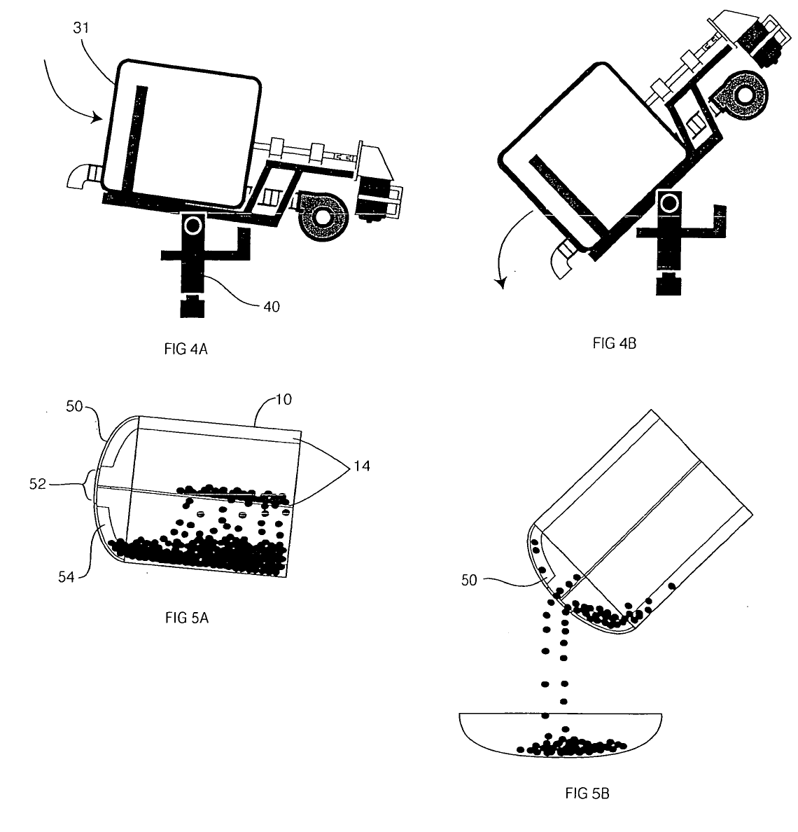

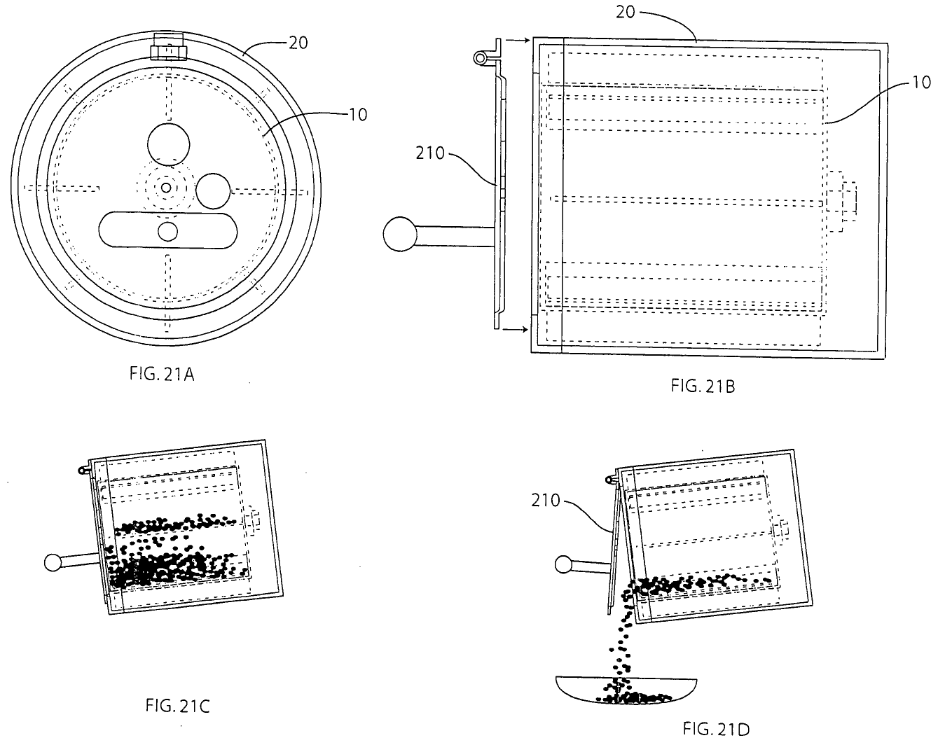

The distinguishing characteristic of any drum roaster is the inner roasting drum, shown in FIG. 1. It is the main component of the coffee roaster and consists of a perforated stainless steel drum (10) having one closed and one open end. The perforations in the wall of the drum (12) serve to permit the passage of heated air, which assists in the roasting process by means of convection heating. Secondarily, the perforations permit the exit of water vapor and the solid chaff cast off the coffee beans during the final stages of the roasting process. Said perforations are numerous, several per square inch, and should be no larger than approximately 3/16″ in diameter, else it becomes possible for the smaller varieties of green coffee beans to pass through or become lodged in the wall of the drum. The drum contains several stirring-fins on its inner surface (14) such that the turning action of the drum causes the beans to be continuously lifted and poured within the volume of the drum. This continuous stirring process, demonstrated in FIG. 5A, is essential for the even roasting of the coffee beans as it provides for an even heating of each bean throughout the roasting process. In one embodiment, the same internal drum may be fitted with fins on its outer surface (16) similar to those on its interior. These fins serve to stir the heated air in the surrounding confined air volume (18), further improving convective air-flow and even heating through and around the drum. Internal airflow is maintained by a high temperature circulating fan (33 in FIG. 20B). The roasting drum has an open end, which is placed at a fixed miniscule distance from a non-rotating door in one end of the roasting chamber, as shown in FIG. 21C. The drum remains free to turn though the door does not rotate. Beans are not allowed to pass out of the drum into the surrounding volume of the roasting chamber because of the close proximity of the open end to the door's internal surface. Beans may be added to the rotating drum through a port in this door, which can then be capped to prevent heat loss. During the roasting process, the condition of the beans may be manually checked by means of an inserted tubular scoop or “doser”. This is typically done during the final stages of roasting and is critical to producing a consistent roast from load to load. Coffee is removed by opening the door or a small sub-door at the open end of the roasting drum. When the roasting drum is set at an appropriate fixed incline of 5 to 15 degrees, opening the sub-door will cause the roasted coffee to pour from the drum (see FIG. 21D).

Motor Drive System

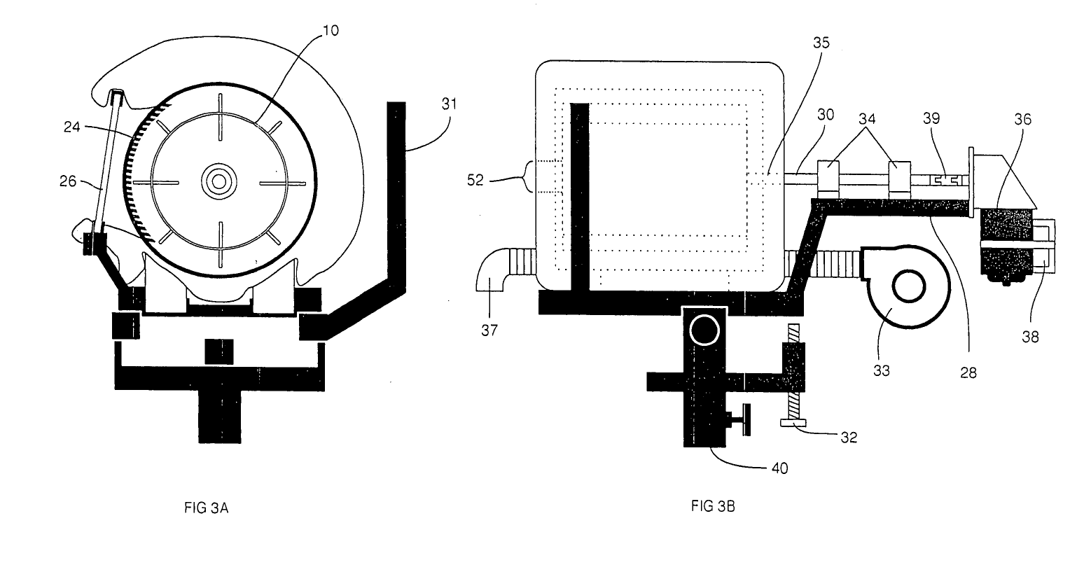

The roasting drum is supported and turned by a stainless steel shaft attached to the closed end, pictured in FIGS. 3A and 3B. The shaft (30) is mounted on a support frame (28) by means of one or more bearings (34) set outside the confined heated air volume. The shaft is turned by a 12-36 volt DC motor (36). In an alternate embodiment, the shaft is turned by an AC motor connected to an electronic speed controller. The motor is geared for high torque low speed operation for rotational speeds between 20 and 60 RPM. The motor may be provided with a small dedicated DC cooling fan (38) to prevent overheating. The motor may be coupled to the shaft by means of a universal joint (39), which enables satisfactory rotary coupling and minimizes heat transfer from the shaft to the motor. In an alternate embodiment, the shaft is turned by a chained sprocket. A motor having a sprocket is linked to the shaft's sprocket by a chain. In a third embodiment, the motor is coupled to the shaft by means of pulley wheels and a belt. In all embodiments, provisions are made so that an adequate amount of heat energy is dissipated by the stainless steel shaft and/or chain or belt arrangement such that the motor is not damaged by the high temperature of the internal drum.

Roasting Chamber

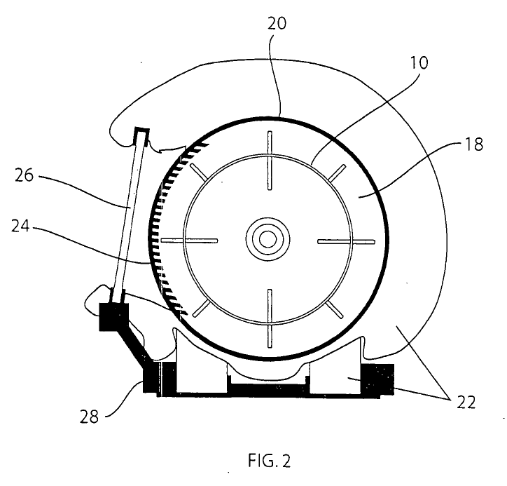

At all times, the inner drum is enclosed in a thermally insulated chamber (20), shown in cross-section in FIG. 2. The chamber serves to contain and circulate a volume of air (18) that is heated by means of solar thermal radiation. The chamber consists of a steel or stainless box or cylinder that is surrounded by suitable thermal insulation (20). In one embodiment, the insulation consists of lightweight flame-resistant fiberglass insulation, wrapped in reflective metal foil. In another embodiment, a rigid kiln-like arrangement is constructed around the outside of the roasting chamber, consisting of low-density fire brick cemented together with refractory concrete. In a third embodiment, a spray on, or cast ceramic insulation material may be used to coat the exterior of the roasting chamber. In all embodiments, the thermal insulation must be capable of withstanding internal temperatures as high as 700 degrees Fahrenheit for a period of as long as 10 hours. This considerable addition of insulation greatly improves the efficiency of the roaster and allows it to maintain internal temperature for longer periods of time, which is important when using a potentially fluctuating energy source such as solar radiation. The insulated roasting chamber may be surrounded by an outer metal box fitted to the outer dimensions of the insulation. Said box encloses and supports the inner chamber and may be mechanically connected to the structure of the solar concentrator, depending on the particular collector type chosen.

Airflow and Receiver Plate

Unlike a traditional drum roaster, the solar drum roaster is constructed with means to entirely recycle the heated air that is passed through the drum. This is accomplished by means of a pair of flue valves (see FIG. 20B, 195 and 196), which can be closed to cut off airflow into and out of the system. At the start of the roasting process, air enters the system through a circulating fan through a flue valve (196). The fan may be a simple squirrel-cage fan that has been adapted such that its walls are insulated and so that very little heat is transferred into the motor. Air is pushed upwards by the fan into the receiver plate. The receiver plate is made of steel or some other metal having high thermal conductivity and a melting temperature above 1500 degrees Fahrenheit. Its outer surface is blackened so that it converts a maximum amount of solar radiation into thermal energy. Ideally, low infrared-radiating black paint, such as the type utilized in evacuated glass solar-tube water heaters, is used. The receiver plate may consist of a series of vertical tubes through which air passes and carries away heat by means of convection. In one embodiment of the receiver, a transparent high-temperature window is placed in front of the receiver plate and framed with insulation so that very little heat is carried away from collector plate by means of air convection. The window may consist of a high temperature transparent ceramic material such as NeoCeram or PyroCeram. Such high temperature windows should be no thicker than ¼ inch, as they typically have some degree of opacity, which begins to offset the heating gains of lowered convection. Windows should be mounted in such a way as to allow thermal expansion of the window mounts, which may place stress on the window if not accounted for, see FIG. 2. It is acceptable for a small amount of airflow to pass into and out of the air region between the window and the collector plate, as an airtight seal results in unwanted thermal expansion issues as well. In another embodiment, a Pyrex glass window is used in place of the transparent ceramic material, as described above.

Heated air from the receiver plate passes into the roasting chamber and up through the rotating drum, heating the coffee. As the coffee beans roast, they shed their outer husks, which exit the drum through its perforations. The chaff is carried out of the roasting chamber through a duct at the top, and into a chaff collection system (193) where it settles to the bottom to be removed later. Chaff removal is important because it greatly reduces the occurrence of roaster-fire, which ruins a given batch of coffee. The heated air then passes out through a chimney, or is diverted by a flue valve (195) through the re-cycling pipe (198). A mesh filter (194) may be installed inline with the recycling pipe in order to further remove particulate matter before it completing its circuit and entering the circulating fan (33). At the end of the roasting process, the roasting chamber may be cooled by removing direct solar exposure from the collector plate, and by opening the flue valves (195 and 196) to allow hot air to be replaced by cool.

Drive Shaft Passage

The roasting chamber has an opening at its rear to allow for the passage of the roasting drum drive shaft (35). The opening is of minimal size and may be lined on the exterior by metal foil, metal brushes, or bunched high-density metal meshes that ride against the shaft in order to minimize air circulation around said shaft. In another embodiment, the drive shaft may pass out of the roasting chamber by means of an air-tight high-temperature sliding seal, preventing airflow out of the chamber.

In a third embodiment, the drive shaft may pass out of the roasting chamber by means of a high-temperature duty bearing, as used in pottery kilns. This also serves to prevent airflow out of the chamber, and provides additional support to the internal drum.

Thermocouple

In one embodiment, a type K thermocouple is inserted through one wall of the roasting chamber so that the internal temperature of the chamber is displayed by a pyrometer. The pyrometer allows the internal temperature to be monitored over a range 100 to 800 degrees Fahrenheit.

In a second embodiment, the end of the thermocouple may be inserted through the door of the roasting chamber. This allows for an accurate direct reading of the temperature within the roasting drum.

In a third embodiment, an IR thermometer system may be employed to take direct readings of the bean temperature through a port in the front of the roaster.

Electrical System

In one embodiment, the drive and fan motors are operated by a low voltage direct-current power supply. The power supply may consist of an external system that includes one or more photovoltaic panels, providing suitable voltage to drive the motors, a charge-controlled battery backup system, and a motor control panel. The motor control panel contains switches that control the external blower fan and the drive motor for the inner drum. Means are provided for electronically controlling the rotational speed of the inner-drum drive motor. This may be accomplished by a large variable resistor or a solid-state DC pulse-width modulation controller, such as those used in cordless drills. Depending on the temperature of the drum during roasting (between 450 and 500 degrees Fahrenheit), the drum rotation speed will be set to an appropriate speed, which will typically be between 20 and 60 rpm. The control panel should be placed on or in close proximity of the roaster module for ease of use. During roaster operation, the photovoltaic panels are set up at a safe distance from the larger roaster-reflector system so that it is not damaged by excessive heating, vibration, or inadvertent collision with the larger system as it swivels to track the sun. In another embodiment of the power and control system, one or more of the motors may be a speed-controlled AC motor, which may require the use of a power inverter. The inverter converts low-voltage direct current to 110 VAC, which can then be used in conjunction with a speed controller to drive the motor.

2. Drum Roaster Module Embodiment #2, Compact System.

An embodiment of a second solar-heated drum roaster is shown in FIG. 20D. This embodiment is a compact version of the previously described roasting system, and is intended for use with smaller scale solar roasters, which may require that the roasting module is elevated in order to track the sun.

Roasting Drum

The internal roasting drum is identical to that described in embodiment #1, except typically smaller. In this compact embodiment, though, the same internal drum may be fitted with fins on its outer surface similar to those on its interior (16), see FIG. 1. These fins serve to stir the heated air in the surrounding confined air volume (18), further improving convective air-flow and even heating through and around the drum. The open end of the inner drum may be fitted with a funnel-like extension (50), see figures 5A and 5B. This extension is directly connected to the drum so that it turns within the heated air volume as well and reduces the open diameter of the drum to a small port (52) typically no more than 4 inches. The shape of the funnel-like extension allows for the adding of green un-roasted beans to the drum while it is turning. The reduced diameter of the open end of the drum prevents beans from escaping while the drum rotates; see FIGS. 4A and 5A. In an alternate embodiment, there is no funnel-like extension. Instead, the drum simply has an open end, which is placed at a fixed miniscule distance from a non-rotating door in the side of the roasting chamber, as described in the first embodiment. The funnel-like lid embodiment enables the direct pouring of roasted coffee from the drum by tipping the entire roasting arrangement so that the open end faces steeply downward, as shown in FIGS. 4B and 5B. The funnel-like extension may be fitted with internal fins (54) similar to those lining the drum. These assist in the pouring of roasted coffee from the drum when the arrangement is tipped.

Motor Drive System

The roasting drum is supported and turned by a stainless steel shaft attached to the closed end, pictured in FIGS. 3A and 3B. The shaft (30) is mounted on a support frame (28) by means of one or more bearings (34) set outside the confined heated air volume. The shaft is turned by a 12-36 volt DC motor (36). In an alternate embodiment, the shaft is turned by an AC motor connected to an electronic speed controller. The motor is geared for high torque low speed operation for rotational speeds between 20 and 60 RPM. The motor may be provided with a small dedicated DC cooling fan (38) to prevent overheating. The motor may be coupled to the shaft by means of a universal joint (39), which enables satisfactory rotary coupling and minimizes heat transfer from the shaft to the motor. In an alternate embodiment, the shaft, as described in the first embodiment, is turned by a chained sprocket. A motor having a sprocket is linked to the shaft's sprocket by a chain. In a third embodiment, the motor is coupled to the shaft by means of pulley wheels and a belt. In all embodiments, provisions are made so that an adequate amount of heat energy is dissipated by the stainless steel shaft and/or chain or belt arrangement such that the motor is not damaged by the high temperature of the internal drum.

Roasting Chamber

At all times, the inner drum is enclosed in a thermally insulated chamber (20), shown in cross-section in FIG. 2. The compact roasting chamber design is also given in schematic view in FIG. 20D. The chamber serves to contain and circulate a volume of air (18) that is heated by means of solar thermal radiation. The chamber consists of a steel or stainless box or cylinder that is surrounded suitable thermal insulation (20). In this compact embodiment, the chaff collection system (193) may also be incorporated directly into the lower section of the roasting chamber. Thermal insulation consists of lightweight flame-resistant fiberglass insulation, wrapped in reflective metal foil. In another embodiment, a rigid kiln-like arrangement is constructed around the outside of the roasting chamber, consisting of low-density fire brick and cemented by refractory concrete. In a third embodiment, a spray on, or cast ceramic insulation material may be used to coat the exterior of the roasting chamber. In all embodiments, the thermal insulation must be capable of withstanding internal temperatures as high as 700 degrees Fahrenheit for a period of as long as 10 hours. The roasting chamber (20) may be attached to the support frame (28, FIG. 2), by means of metal straps, which wrap around the roasting chamber. In another embodiment, elongated stainless bolts mechanically couple the internal metal roasting chamber to the support frame. Such bolts extend through an acceptable thickness of insulation, minimizing direct heat transfer from the roasting chamber to the external frame. In another embodiment, the roasting chamber is coupled to the external frame by means of stainless bolts that attach directly to a rigid insulation shell (fire bricks or cast ceramic for example) such that there is no direct metal-to-metal thermal transfer from the roasting chamber to the support frame. In a fourth embodiment, the insulated roasting chamber may be contained in an outer metal box fitted to the outer dimensions of the insulation. This encloses and supports the inner chamber, and is directly connected to the support frame.

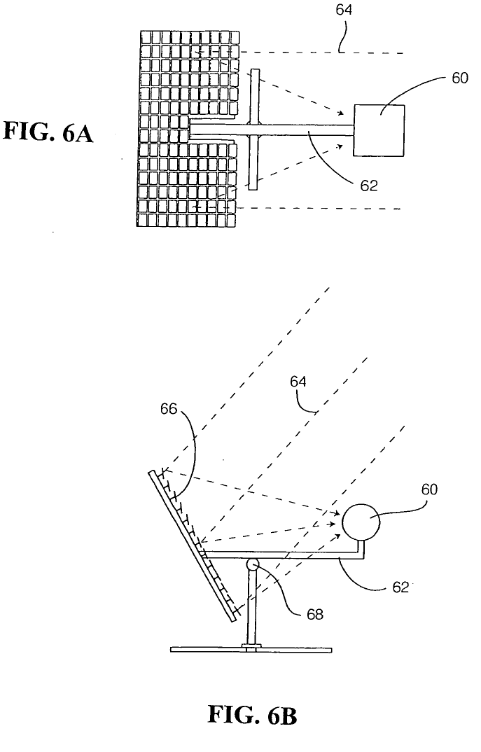

Since the compact embodiment will be mounted on a solar concentrating structure, the base of the roasting module terminates with a square tube-steel socket (40) (FIG. 3B). This socket is fitted with a mounting clamp, and is sized to slide onto a pipe-end that protrudes from the end of the large main arm of the solar concentrator support frame (62, in FIGS. 6A, 6B). By loosening the clamp, the drum roaster module may be lifted free of the arm for servicing or storage. One alternate embodiment of this attachment scheme provides for the socket of the previous embodiment to be attached to main arm of the solar concentrator support frame, and a compatible pipe end to be attached to the bottom of the roaster module.

Airflow and Receiver Plate

In this embodiment, air within the chamber may be stirred by external fins attached to the rotating inner drum. The stirring action ensures that the air passes over the inner surface of the heated solar receiver plate (24), which is fitted directly into the wall of the roasting chamber. A high temperature circulating fan is placed outside the roasting chamber and causes air to blow through the inner surface of the receiver plate, which is directly integrated into one wall of the roasting chamber (see FIG. 2). The receiver plate is made of steel or some other metal having high thermal conductivity and a melting temperature above 1500 degrees Fahrenheit. Its outer surface is blackened so that it converts a maximum amount of solar radiation into thermal energy. Ideally, low infrared-radiating black paint, such as the type utilized in evacuated glass solar-tube water heaters, is used. In one embodiment, the inner surface of this receiver plate has radiator fins to improve thermal transfer to the circulated air inside. In another embodiment, the receiver plate consists of a series of vertical tubes, through which air is forced by means of a circulating fan. The hot air then moves to the coffee beans, which are stirred within the drum. The internal airflow may be further adapted by means of a scoop (201) placed on the internal wall of the roasting chamber below the inner surface of the receiver plate, as shown in FIG. 20D. The scoop (201) directs the heated air upward, moving air up through the bottom of the rotating drum, improving the flow of air over the beans. The heated air then exits the roasting drum through a flue valve (195), or is recycled by passing through a wire mesh filter (199) and then back into the recirculation fan (33).

In one embodiment of the receiver window, a transparent high-temperature window (26) is placed in front of the receiver plate and framed with insulation so that very little heat is carried away from collector plate by means of air convection. The window may consist of a high temperature transparent ceramic material such as NeoCeram or PyroCeram. Such high temperature windows should be no thicker than ¼ inch, as they typically have some degree of opacity, which begins to offset the heating gains of lowered convection. Windows should be mounted in such a way as to allow thermal expansion of the window mounts, which may place stress on the window if not accounted for, see FIG. 2. It is acceptable for a small amount of airflow to pass into and out of the air region between the window and the collector plate, as an airtight seal results in unwanted thermal expansion issues as well. In another embodiment, a Pyrex glass window is used in place of the transparent ceramic material, as described above. In a third embodiment, no glass covering is used, allowing the outer surface of the receiver plate direct exposure to concentrated sunlight. In such an arrangement, it may be advantageous to set the receiver plate into a deep indentation, surrounded by the insulation of the roasting chamber. The indentation serves to reduce convective airflow around the outer surface of the receiver, improving efficiency.

The drive shaft passage, thermocouple, and electrical system of the compact embodiment are identical to those described in drum roaster module embodiment #1.

3. Drum Roaster Module Embodiment #3, Simplified System

FIG. 20E is a system schematic of this particular embodiment. This system is intended to be a low-cost small-scale solar roaster, having roast quantities of less than 5 pounds. It differs from embodiment #2 in its airflow system. There is no chaff collector; an exit port at the front allows chaff to be blown out of the chamber. The port may be fitted with a valve so that it may be closed to conserve heat during roasting. The high temperature circulating fan is replaced by a simple squirrel-cage fan, which cools the roasting chamber while evacuating it of chaff. All other subsystems are identical to those of embodiment #2.

B. Fluid Bed Coffee Roaster

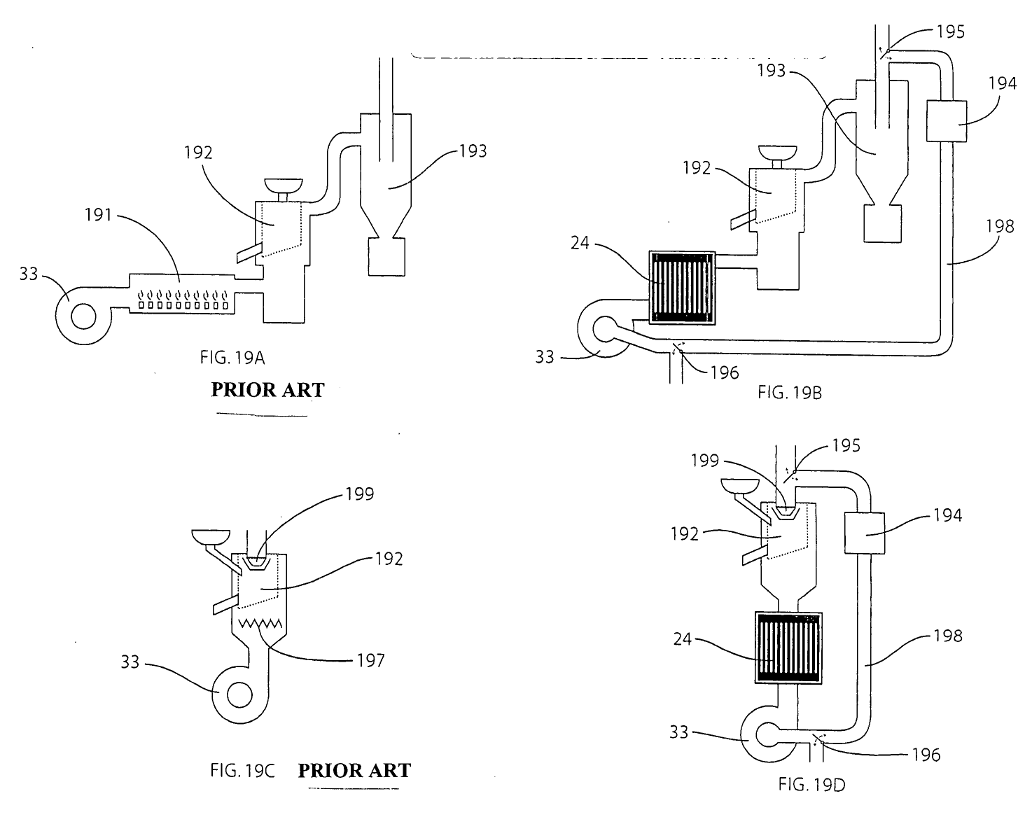

FIG. 19A is a system schematic of a natural gas heated Fluid Bed Roaster, according to the prior art. In this system, a blower fan (33) forces air through a burner system (191). The hot air is then blown into the fluid bed roaster, where it is forced upwards through the roasting chamber (192). The coffee beans are suspended in the high velocity updraft of heated air, roasting them evenly and without contact with any surfaces. The heated air then passes out of the roasting chamber, carrying with it the chaff cast off the beans. The air moves into the chaff collection system (193) where solid particulate material settles to the bottom while air passes out through a chimney or flue.

FIG. 19C is a system schematic of an electrically heated fluid bed roaster, according to the prior art. In this system, a blower fan (33) forces air over a resistive heating element (197) and upwards through the roasting chamber. The coffee beans are suspended in the high velocity updraft of heated air, roasting them evenly and without contact with any surfaces. The heated air then passes out of the roasting chamber through a wire mesh filter (199), while particulate chaff material remains behind in a small collection tray.

1. Fluid Bed Roaster Module Embodiment #1, Large-Scale

A large-scale embodiment of a solar heated fluid bed roaster system is shown in a system schematic diagram in FIG. 19B. In this system, fresh air may be taken in through a port connected to an intake valve (196) and forced by a high temperature circulating fan (33) into the receiver plate module (24). Air is heated within the receiver plate and is blown into the roasting chamber (192), where it suspends beans in an upward draft of air. The air and chaff from the beans then pass out of the roasting chamber and into a chaff collection system (193) where the particulate material settles to the bottom. The air may then pass out of the system through a flue at the top, or may be diverted by a valve (195), through a secondary mesh filtration system (194) before being returned to the circulating fan by means of an insulated return duct (198).

The circulating fan and other electrical components may be powered by means of collected solar energy in the same manner described in the first embodiment of the drum roaster system.

2. Fluid Bed Roaster Module Embodiment #2, Compact System

A compact embodiment of a solar heated fluid bed roaster system is shown in a system schematic diagram in FIG. 19D. In this system, fresh air may be taken in through a port connected to an intake valve (196) and forced by a high temperature circulating fan (33) into the receiver plate module (24). Air is heated as it passes through receiver plate, which is directly incorporated into the bottom of the roasting chamber, and is blown into the roasting chamber (192), where it suspends beans in an upward draft of air. The air and chaff from the beans then pass out of the roasting chamber through a small wire mesh filtration system (199), which allows the chaff to settle into a tray. The air may then pass out of the system through a flue at the top, or may be diverted by a valve (195), through a secondary mesh filtration system (194) before being returned to the circulating fan by means of an insulated return duct (198).

The circulating fan and other electrical components may be powered by means of collected solar energy in the same manner as described in the first embodiment of the drum roaster system.

Since the compact embodiment will be mounted on a solar concentrating structure, the base of the roasting module terminates with a square tube-steel socket (40) (FIG. 3B). This socket is fitted with a mounting clamp, and is sized to slide onto a pipe-end that protrudes from the end of the large main arm of the solar concentrator support frame (62, in FIG. 6A). By loosening the clamp, the drum roaster module may be lifted free of the arm for servicing or storage. One alternate embodiment of this attachment scheme provides for the socket of the previous embodiment to be attached to main arm of the solar concentrator support frame, and a compatible pipe end to be attached to the bottom of the roaster module.

II. Solar Thermal Concentrating Reflector

A large solar thermal concentrator is used to collect a substantial area of direct solar radiation and then focus it onto the receiver plate of a solar coffee roaster module. The concentrator is a curved reflector or system of many smaller reflective mirrors, and is capable of adjusting its position with respect to the sun throughout the day in order to maintain proper focus. The concentrator must collect enough solar power to roast a given quantity of coffee within 12-20 minutes. The coffee roasting process requires the beans to be maintained at or above 450 degrees Fahrenheit. Through experimentation, it has been found that coffee roasting requires roughly 2 kilowatts (6823 BTU/hour) of power per pound, through an 18 minute roast. This is roughly concurrent to the power required by several exemplary commercial drum roasters, produced by the German manufacturer Diedrich:

BASED ON 16 MINUTE ROASTS AT 425 F.

| OUTPUT (LBS) | POWER (BTU/HR) | POWER/LB (BTU/HR) |
|---|---|---|
| 3-11 | 24,000-63,000 | 8000-5727 |
| 10-33 | 48,000-130,000 | 4800-3939 |
| 20-66 | 200,000-500,000 | 10000-7575 |

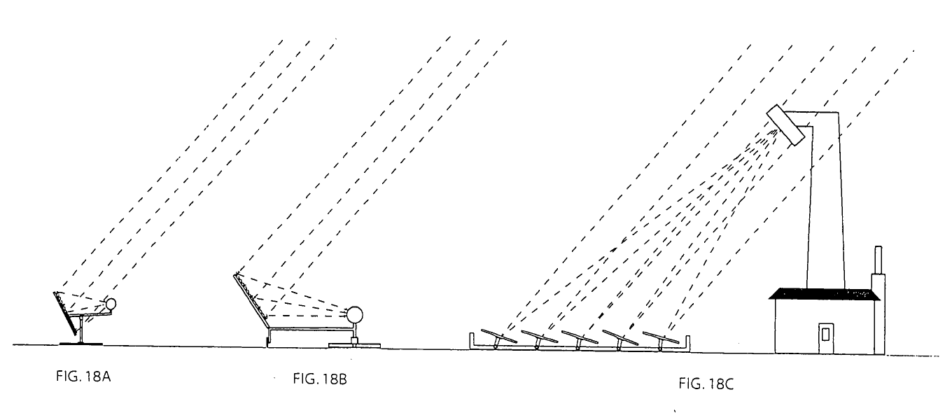

Direct sunlight has a power density of roughly 1 kilowatt per square meter, and the glass mirrors tested by the inventor were found to have a reflectivity of 95%. With these mirrors, a captured area of solar radiation equivalent to 2.1 square meters (22.6 square feet) is required for each pound of roaster capacity. Such demanding collector surface areas can be achieved for roasters of small, medium, and large scale capacities by adopting an appropriate collector configuration in each case. FIGS. 18A, 18B, and 18C demonstrate three different collector configurations. They are the small fixed mirror type (18A), the medium center-pivot type (18B), and the large power-tower type (18C). Each of the three concentrator configurations can theoretically be used to provide heat to any of the previously described solar-roaster modules, though the ideal pairing of roaster to concentrator will be discussed in the following preferred embodiments:

A. Concentrator Embodiment #1: Fixed Mirror

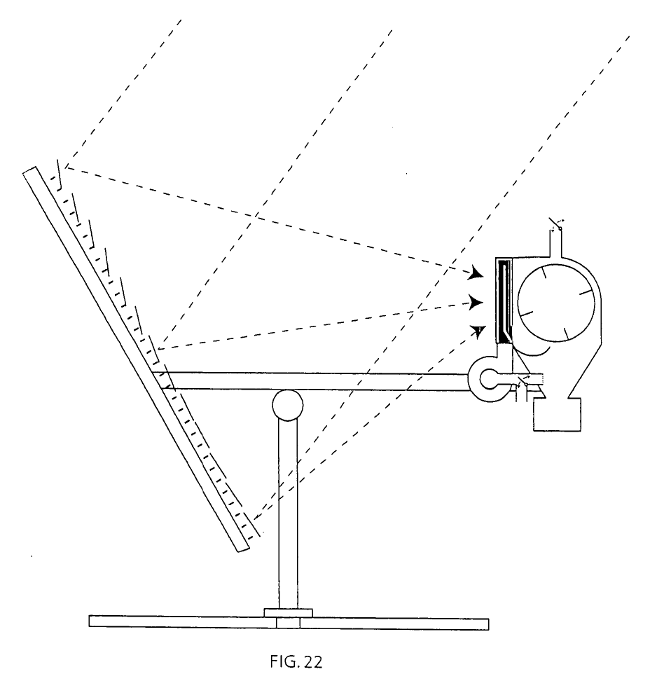

The fixed mirror configuration of the solar roaster is intended for solar roasters having capacities between 1 and 5 lb/roast. These small roaster systems are best embodied through the use of the compact versions of either the drum or fluid bed roaster modules, as described in section I. FIG. 22, for example, illustrates a fixed mirror solar roaster fitted with a compact solar drum roasting module.

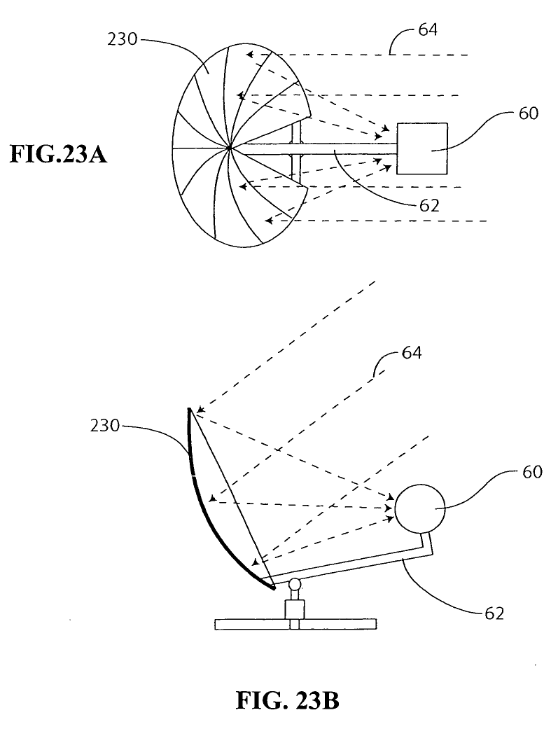

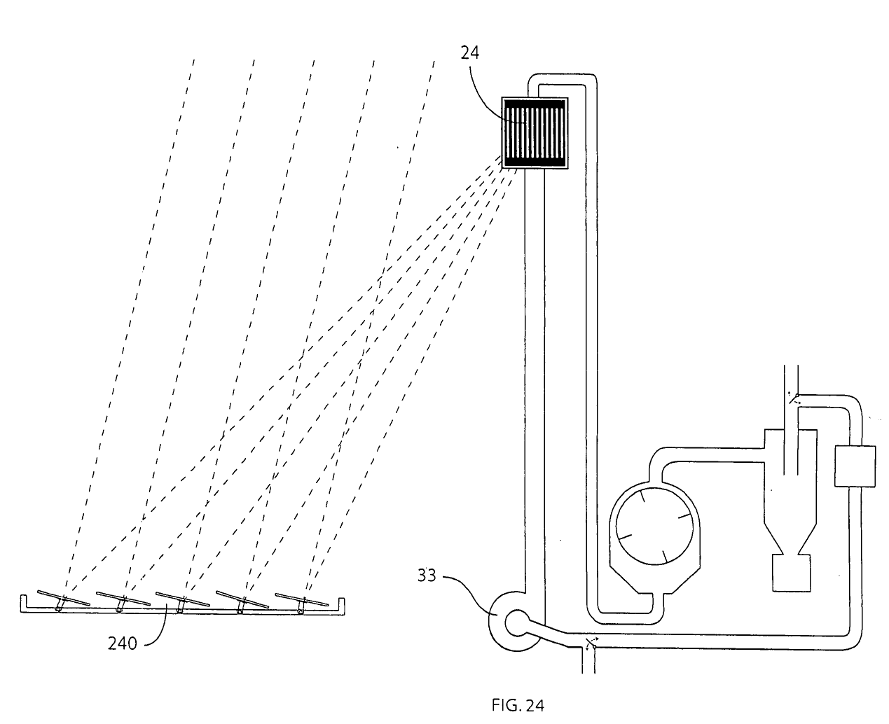

In one embodiment of the fixed mirror design, the reflector may be a continuous curved surface (see item 230, FIG. 23.) The surface may be formed from polished metal, or made from fiberglass and covered with reflective Mylar. The reflective surface is attached, along with the roaster module (60) to a pivoting support structure (62) that is capable of tracking the sun in two axes.

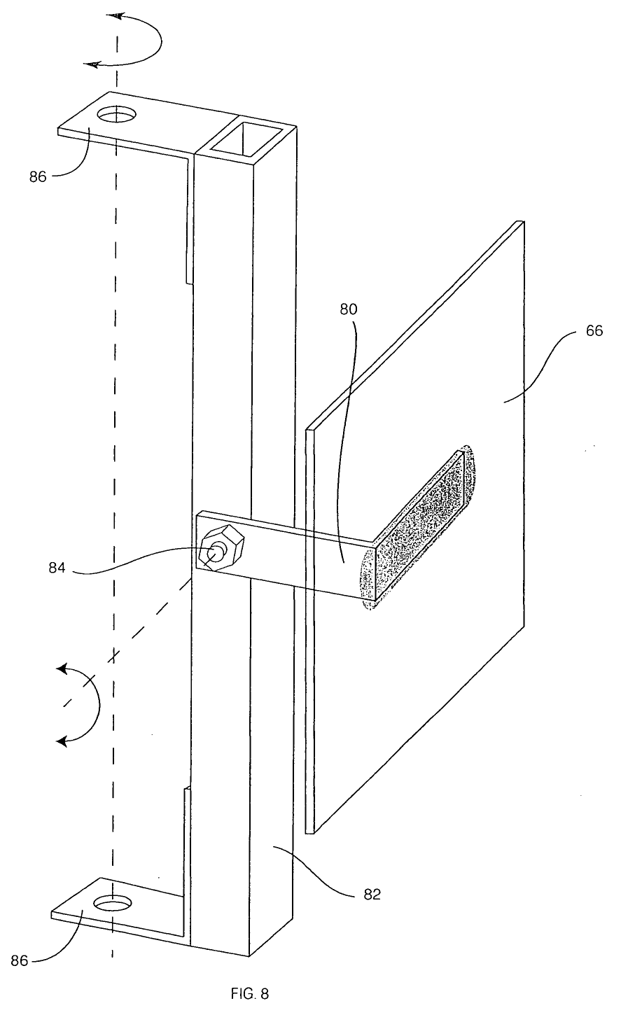

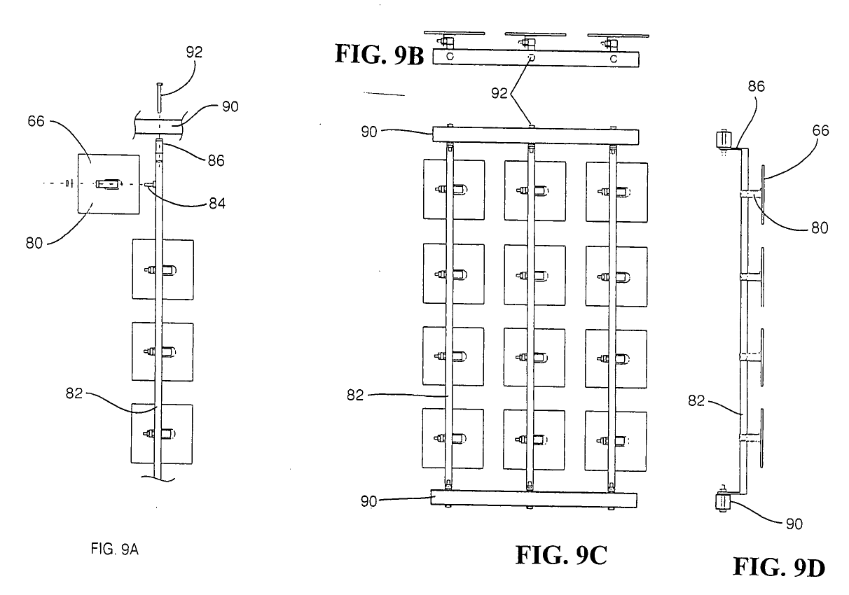

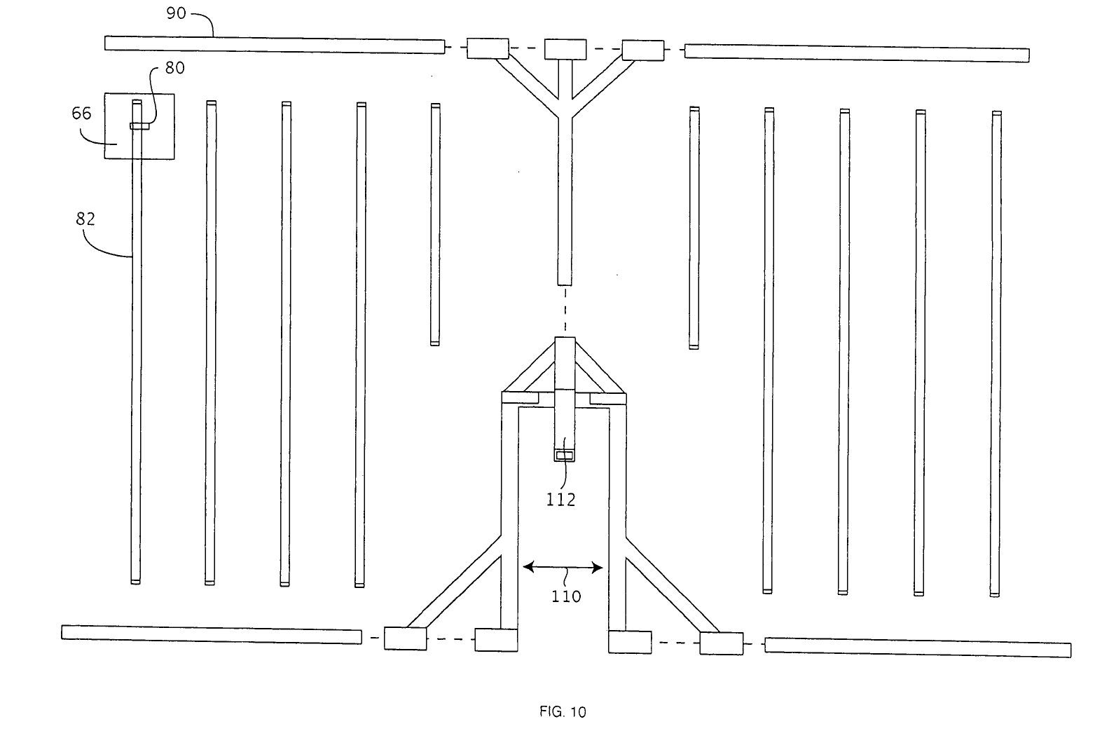

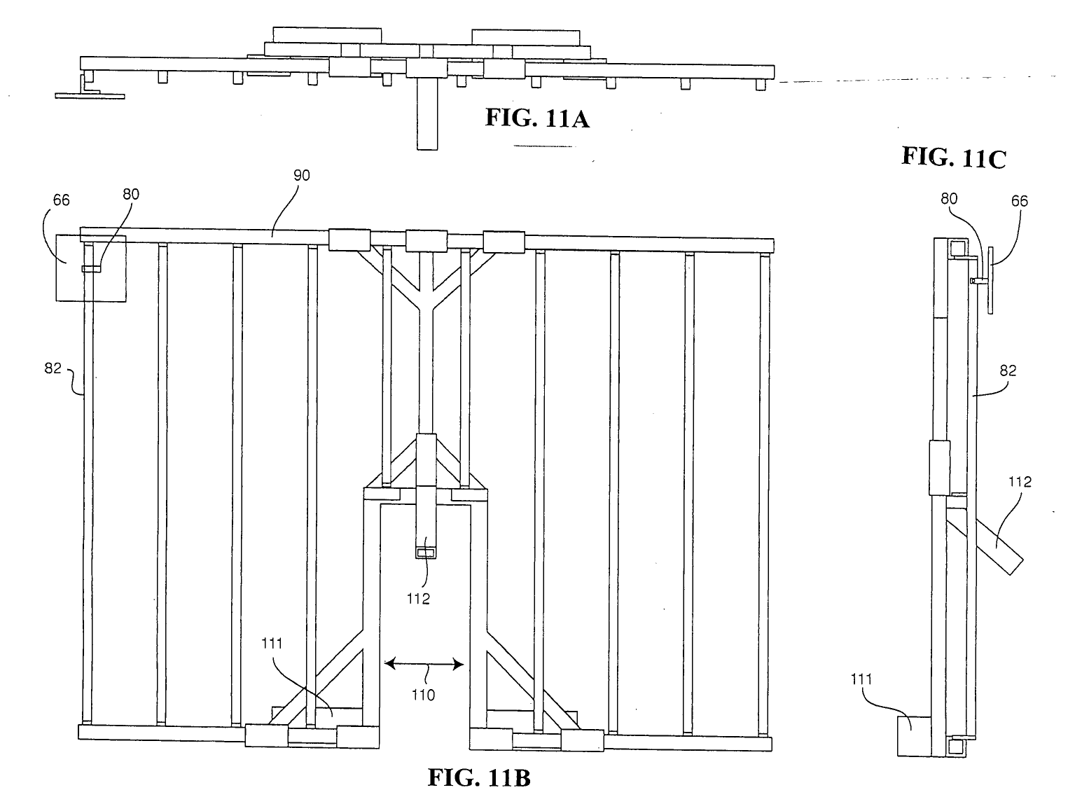

In one embodiment of the fixed mirror design, the reflector system is formed from an array of multiple individually aligned flat mirrors (66), as shown in FIG. 6. It has been shown that a system comprising separate mirrors having airspace between said mirrors is less susceptible to structural damage by strong wind than a large single surface reflector. The mirrors are each bolted to a support rack and can be manually set and locked into place, see FIG. 8. Each mirror (66) is attached to an “L” bracket (80) by means of an epoxy or silicone based adhesive. Each “L” bracket is then attached to a vertical rod of square tube pipe (82) by one of several evenly aligned bolts (84). Each vertical rod is supported at the top and bottom by attached “L” brackets (86). These brackets attach to horizontal support beams (90) by means of nuts and bolts (92), as pictured in FIGS. 9A and 9B. FIGS. 10 and 11 demonstrate the assembly of the mirror support system from constituent rods and beams, to form a large-scale compound collector that can be aligned as a unit to the sun. All the mirrors supported by a given rod can be set horizontally by rotating the rod, and vertically by tipping the bracket of each individual mirror. Once a mirror is properly aligned, it is fixed into place by tightening the bolts with lock-washers.

The advantage of the discreet mirror approach is that it does not require the construction of mathematically precise surfaces and so is more easily constructed. Also, since the mirrors can be individually realigned, the focal properties of the total reflector can be adjusted and re-aimed as needed, allowing one unit to be used with various designs and placements of potential receivers. Finally, by opting for multiple flat mirrors rather than a single curved surface, it is possible to use highly reflective glass or metal mirrors that can be easily cleaned or individually replaced if necessary. This is in contrast to the use of silver Mylar, which is easily scratched or otherwise damaged by cleaning. An alternative to glass or metal mirrors is to use acrylic plastic mirrors, or Mylar coated plastic mirrors.

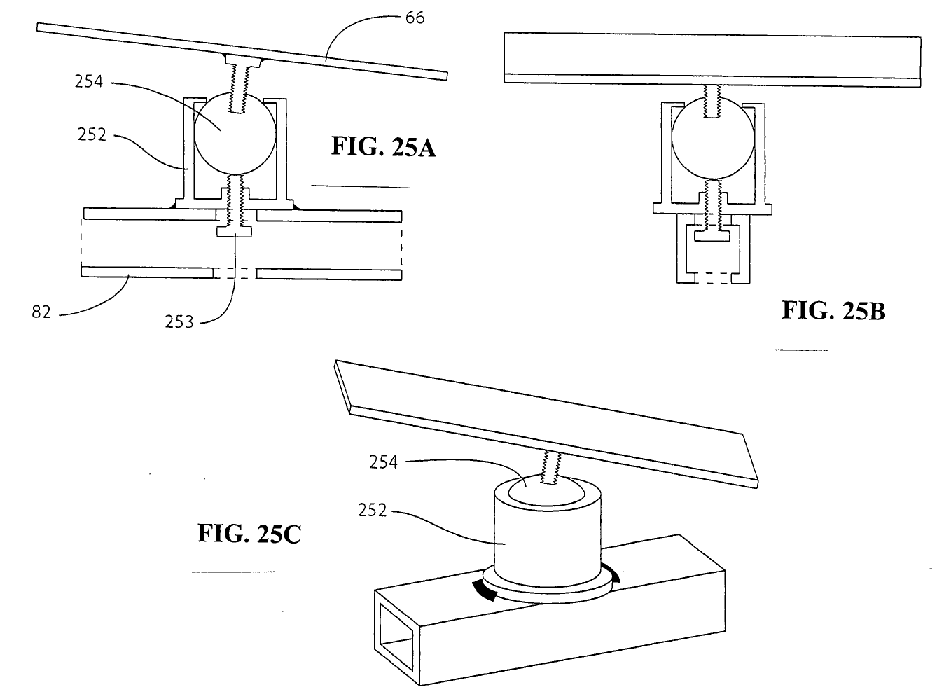

An alternate method for mounting discreet mirrors to support structure is illustrated in FIG. 25. In this system, a mirror (66) is attached to a rubber, plastic, or steel ball (254), which rides in an enclosed metal cup (252). The mirror is manually adjusted so that it is in the proper position. The ball is then fixed into position by means of a cup-ended tightening bolt (253).

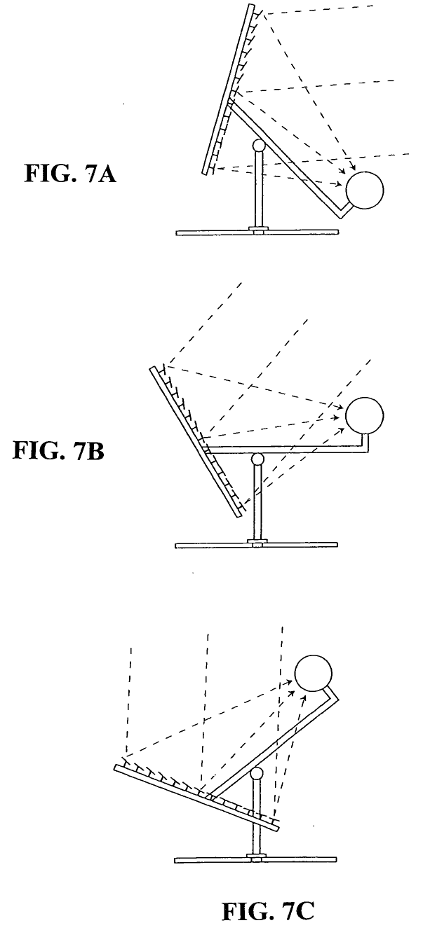

In the first embodiment of the solar concentrator, the focus of the solar coffee roaster is set well below the centerline of the reflector, illustrated in FIG. 14. The angular lowering of the focus, as much as 30 or 40 degrees, allows the user (‘Roastmaster’) safe access to the roaster during operation without having to stand directly above or lean into the reflector when the sun is at its highest point in the day. The roaster module is set below the level of incoming rays of sunlight (64), illustrated in FIG. 7, preventing the shadow of the roaster module or the user from impinging on the total surface area of the reflector. The reflector will have a focal length proportionally longer than a typical parabolic reflector dish. An elongated focal length, one greater than ⅔ the total width of the reflector, serves to physically remove the user from the area nearest the mirrors, reducing the risk damage to the reflector(s) by accidental contact. In another embodiment of the collector, the focus may be set higher, and the mirrors or reflective coating of the reflector may be omitted from the area that is covered by the shadow of the roaster module. This system may be easier to balance, but is less efficient than the system having a lowered focus, and may be more dangerous for the user, as the roaster module must be raised to a greater elevation at mid-day.

A third embodiment utilizes reflectors comprising reflective Mylar membranes stretched across partially evacuated flattened-cylindrical drums. The negative air pressure within the flattened drum causes the surface of the Mylar to indent with an approximately parabolic concavity. One or several such sealed concave reflectors may be grouped on a support frame to direct collected sunlight to the appropriate focus.

Note in FIG. 11 that the reflector support frame provides a gap (110) that allows the passage of the base pole of the system. This gap is required when the reflector is set to a high elevation, as shown in FIG. 7.

Tracking the Sun

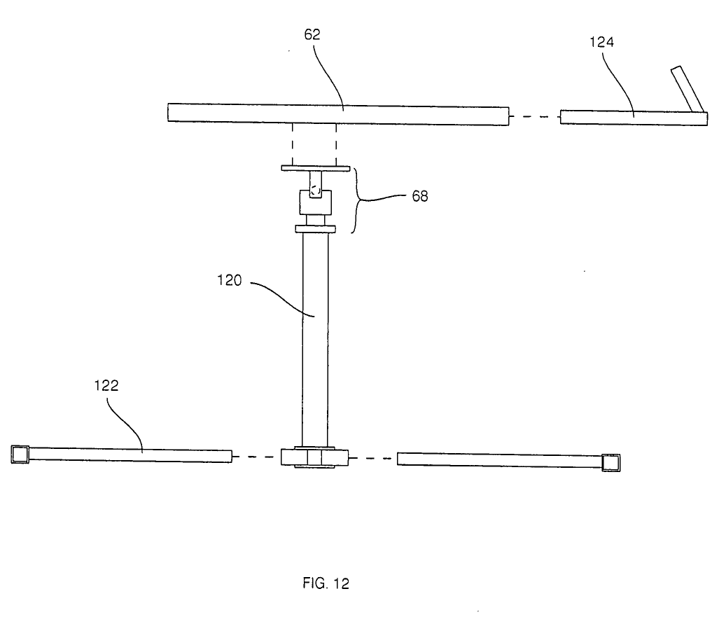

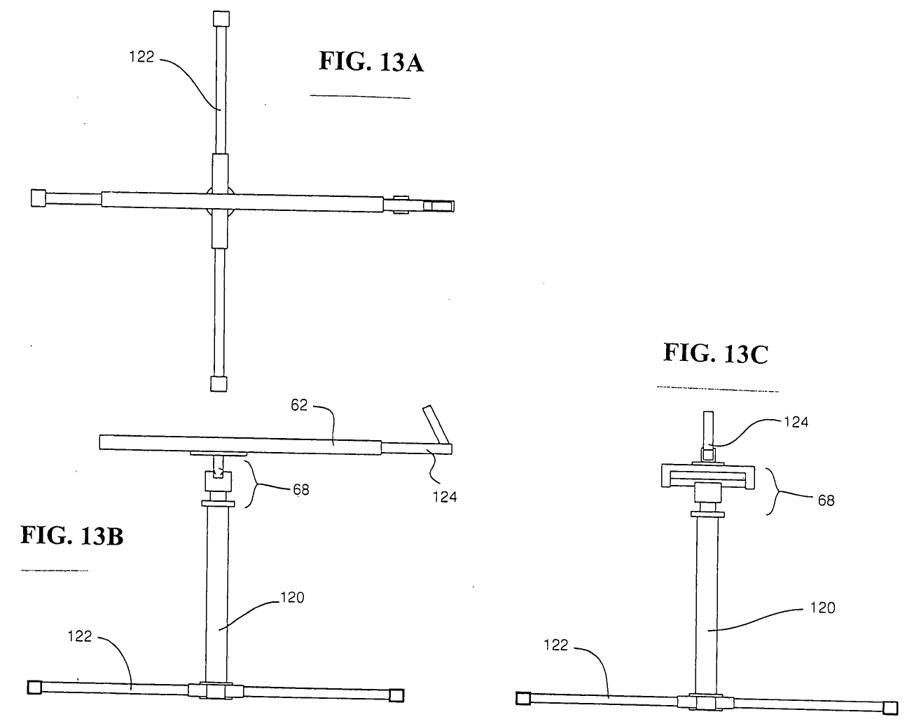

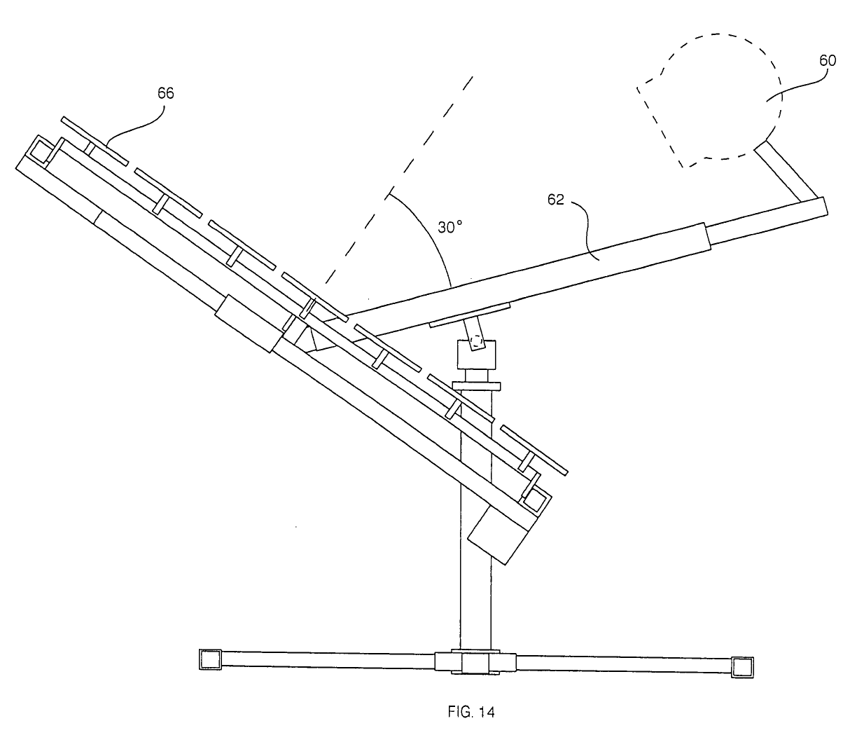

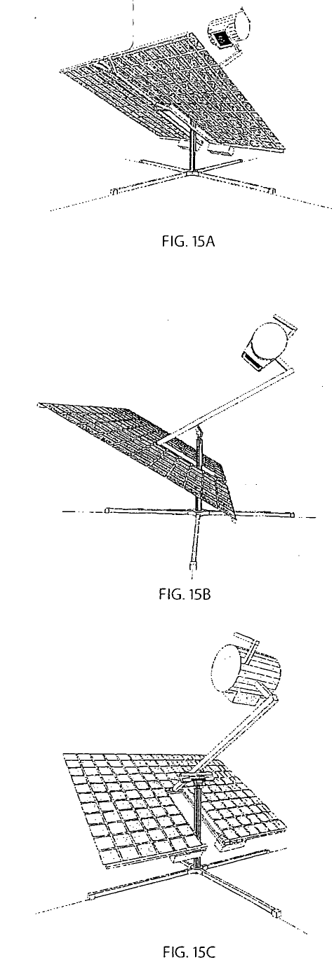

The reflector system has fixed optical properties and must be moved in its entirety in order to track the sun in two axes. In one embodiment, the reflector frame is attached to one end of the main support arm (62) by means of an extended and appropriately angled socket arrangement (112). As shown in FIG. 12, the main support arm (62) is bolted to and articulated by a two-bearing arrangement (68), which allows it to track horizontally and to pitch vertically. The bearing arrangement is attached to the top of a vertical base pipe (120) that contains sockets at its base, into which the support legs (122) may be fitted and held fast by clamping bolts. The sun is tracked by aligning the combined reflector-roaster system to the sun so that the focus is directed into the receiver window of the roaster module.

In a third embodiment, the arm described in the previous two embodiments is replaced by a lattice or truss composed of metal tubes and/or rods. This serves to reduce weight and adds a degree of stability in the case that the system is scaled to be very large.

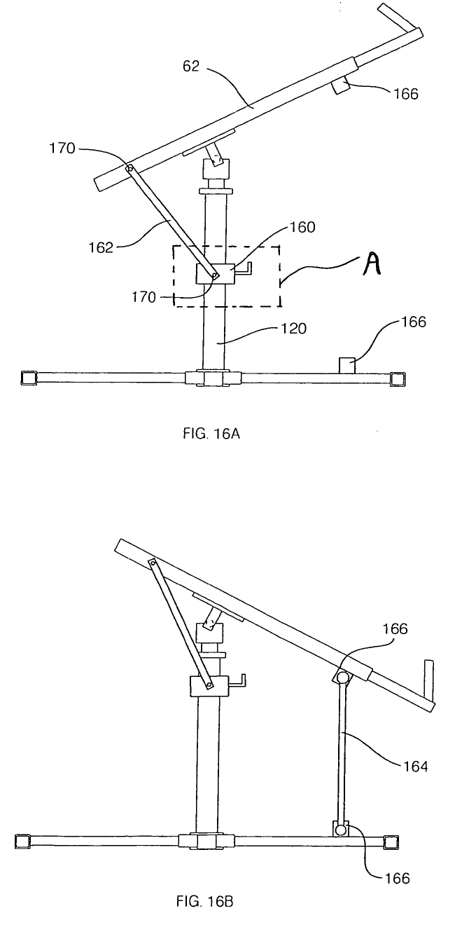

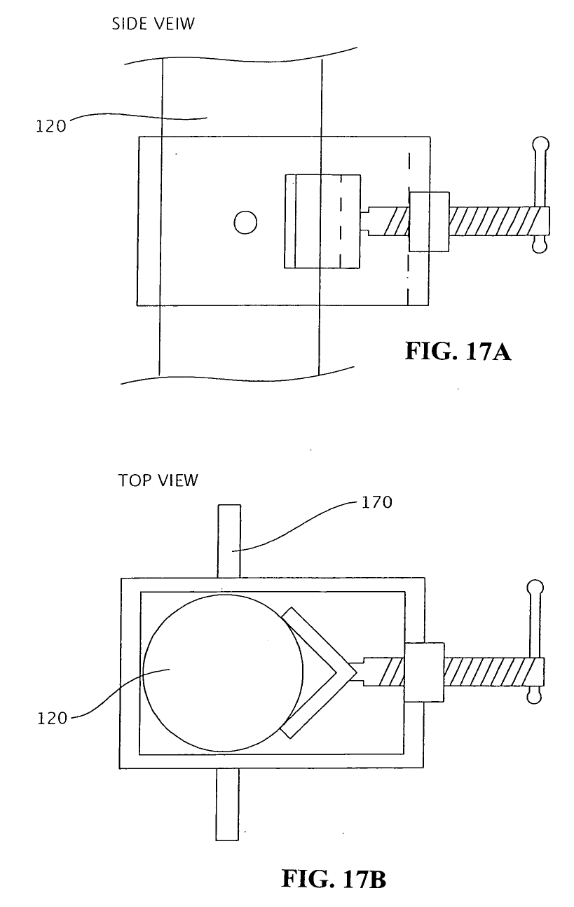

Tracking of the sun, in one embodiment on of solar roaster, is accomplished manually with the use of a sundial like alignment scope. A handle may be provided on the main arm as a convenience for manual alignment. A motorized semi-automatic alignment system is not strictly necessary, as the user (‘Roastmaster’) is already disposed to pay close attention to the roaster during the roasting process. It is only a small addition of duties to maintain proper alignment during roasting, making small adjustments to the angle of the system every 5 minutes (roughly equal to three or four adjustments per roast). Ideally, the system of the reflector and the roaster module will be supported from a pivot point at the system's center of mass. This allows the user to track the sun with minimal mechanical effort. The center of mass is set appropriately low by means of a pair of counter weights (111) placed on the lower horizontal beam of the reflector frame, pictured in FIG. 11. Further fine-tuning of the balance of the system is accomplished by changing the length of the main support arm by sliding the extendable section (124), which supports the roaster module. The extendable section is held fast when set by bolt clamps. When aligning the roaster to the sun manually, the position of the system is held in place between adjustments by means of a movable clamp (160), as shown in FIGS. 16A and 16B. The clamp is connected to the main support arm (62) by a pair of struts (162). The struts attach to the clamp and to the main support arm by means of bolts (170) that allow for free rotation. When loose, the clamp is free to rotate about the circular diameter of the base pole (120) as the arm is panned horizontally, and free to slide up and down the base pole as the arm is elevated vertically. When applied, the clamp, shown in detail in FIG. 17, prevents movement in either axis, effectively freezing the reflector position.

Another embodiment of the tracking system uses a pair of low-speed motors to automatically track the sun in two axes. Both motors are given solar-position feedback information from sensors placed on the movable reflector. As the apparent position of the sun changes, the sensors detect a shadow falling to one side or the other, and activate a motor for that axis to compensate for the change. A high-torque rotary motor is used to control the heading of the reflector system. It may be coupled to the base pole by means of a rubber friction wheel. A provision should be made to allow this motor to disengage so that the reflector can be manually swiveled off axis to remove the coffee without damage to the motor. A linear motor, as used to actuate satellite antennas, is used to control the pitch of the reflector. The motor can be manually activated or mechanically disengaged in order to lower the reflector in order to remove the coffee.

A third embodiment of the system tracks the sun with a single motor about a polar axis. The motor has fixed rotational speed and is geared for extremely low and controlled RPM, such as the type used for polar tracking telescope mounts. The motor is attached to the movable upper section of the reflector system, and rides against a raised stationary circular track. The track is attached to the top of the stationary base pole of the roaster, and is fixed at an angle so that its plane is parallel with the plane of the Earth's equator. In operation, the motor simply rolls about the fixed circular track, keeping time with the Earth's rotation. The motor shaft makes contact with the plate with one or more rubber rollers or with a gear-tooth arrangement. The main arm of the roaster may be quickly detached from the motor such that the reflector may be swiveled manually in order to remove coffee. The arm may then be reattached to the motor, which continues to track the sun regardless of the roast cycle. Once the motor has been manually set to an appropriate angle, it will continue to track the sun throughout the day along the fixed equatorial path and is reset at the start or end of each day. Small adjustments may be periodically made to the length of the connection between the motor and the reflector system; this corrects for seasonal changes in solar elevation.

Safety System

In one embodiment of the system, a short removable ‘safety strut’ (164) may be used, pictured in FIGS. 16A and 16B. When employed, the strut couples the main arm of the support frame (62) to one leg of the roaster base (122). This strut attaches by means of a pair of rings or sockets (166) placed on the roaster frame and leg, and locks the entire system into a fixed position. This allows for the safe tipping, storage, or removal of the roaster head. Note that, without the roaster head in place on the main arm, the reflector system will be greatly out of balance and will tend to swing downward with some force. For this reason, it is critical to make sure the safety strut is securely held into its sockets by means of pins or safety chains as seen fit.

Alternately, the safety strut could be incorporated into one of the leg sections of the roaster so that it simply lays parallel to the leg on the ground when not in use. The leg may be easily elevated into position by the user (‘Roastmaster’) by stepping on a lever plate attached to the strut near its pivot point on the roaster support leg. The main arm can then be attached to the free end of the safety strut, securing the system. Using a pivoting safety strut allows the user (‘Roastmaster’) to keep both hands on the main arm while securing the roaster system. This allows for more control and ultimately greater safety.

B. Concentrator Embodiment #2: Center Pivot

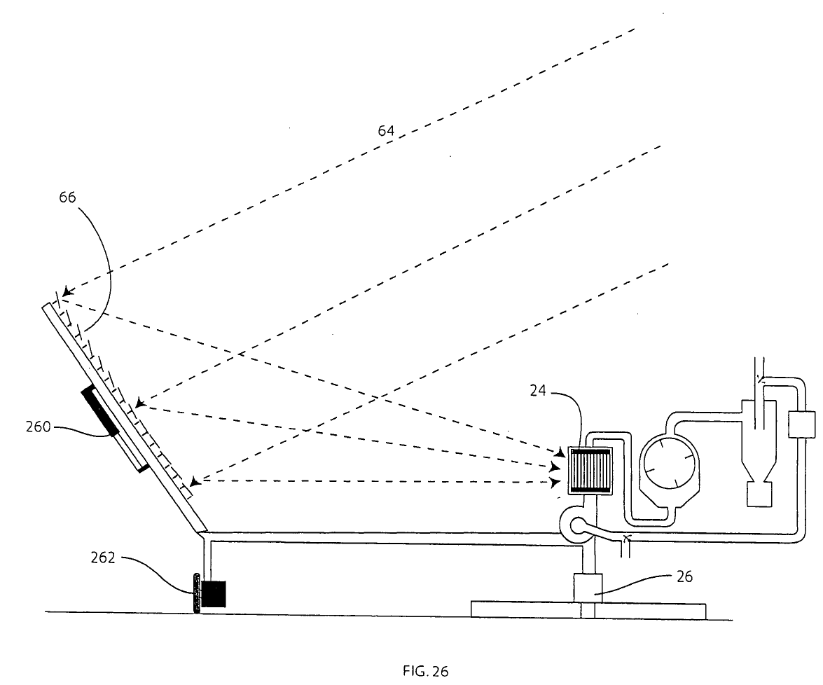

The center pivoting configuration of the solar roaster is intended for solar roasters having medium to high volume capacities, between 5-100 lbs per roast. These roaster systems are best embodied through the use of the larger roaster versions of either the drum or fluid bed roaster modules, as described in section I. FIG. 26 illustrates a center pivot solar roaster that utilizes a drum-type solar roaster module.

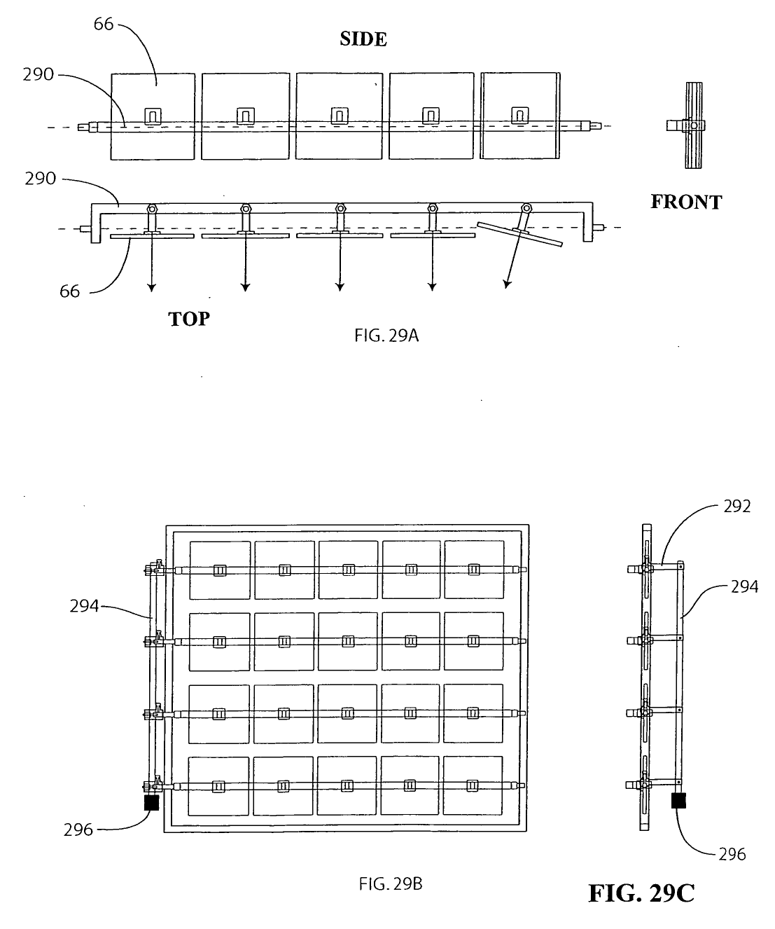

The distinguishing characteristic of the center-pivoting configuration is that the reflector is made up of many multiple mirrors or flat reflective surfaces. Shown in FIG. 31, mirrors (66) are attached to metal support rods (290) to form horizontal rows. Each mirror may be glass, polished metal, plastic, or may be simply a flat surface covered with silver Mylar. The mirrors are supported on “L” brackets, which can be rotated on their point of attachment in one axis in order to achieve horizontal convergence of reflected rays. The mirrors are then fixed into position by bolts and lock washers. As shown in FIG. 29A, each horizontal support rod (290) terminates at either end with short sections of circular shaft. The small shaft sections stand out from the support rod such that their shared rotational axis (shown as dotted line in FIG. 29A) intersects a point near the middle of each mirror when tipped. This positioning of the rotational axis allows the mirrors to be rotated vertically about their center points when the row is tipped vertically on the shafts. This is important because it allows the vertical position of the focus to remain unchanged, regardless of the elevation of the sun.

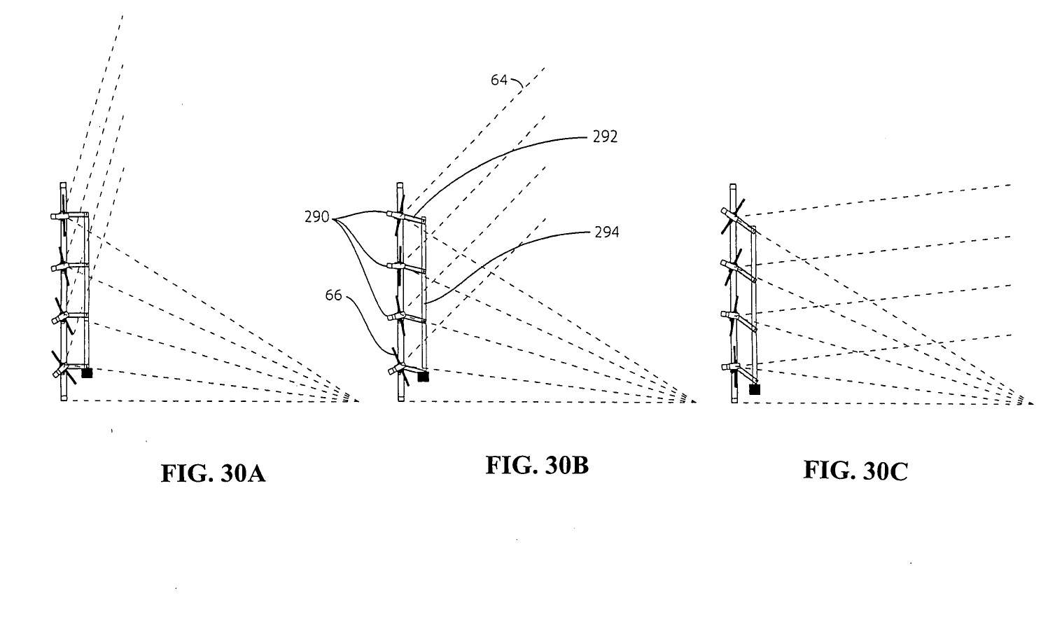

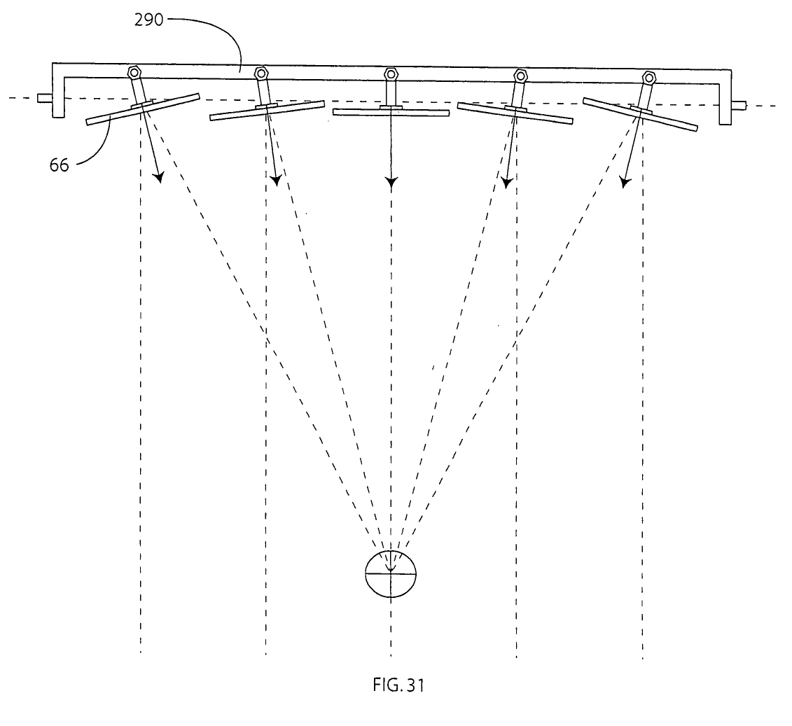

As shown in FIG. 29B, the horizontal rows of mirrors are incorporated into a support frame. A lever arm (292) is attached to the short shaft at one end of each row by means of a screw-setting collet. All lever arms are then cross-connected by a vertical rod (294), which connects via pivoting bolts. In the preferred embodiment, the lever arms and the cross-connecting rod all face forward, in the same direction as the mirrors. In this way, the combined weight of the horizontal mirror rows may be precisely counter balanced by a single weight (296) attached to the vertical rod (294). In this configuration, a relatively low-power motor may be used to drive the elevation setting of a large number of horizontal rows. It may also be desirable to support the horizontal rows with low friction bearings where they pass through the support frame. Once mirror rows are mounted in the support frame and cross connected, they system may be aligned. Mirrors of each row are first set horizontally, as shown in FIG. 31. As shown in FIG. 30, each horizontal row is then given a specific vertical tilt with respect to its lever arm. Once a row is set into position, its rotation relative to the lever is fixed by tightening the collet set screws. Once the relative rotation for each row is set, all rows can be tracked to the sun's elevation by raising or lowering the vertical rod (294). FIG. 30 illustrates a consistent vertical focus maintained through three different elevations of solar exposure.

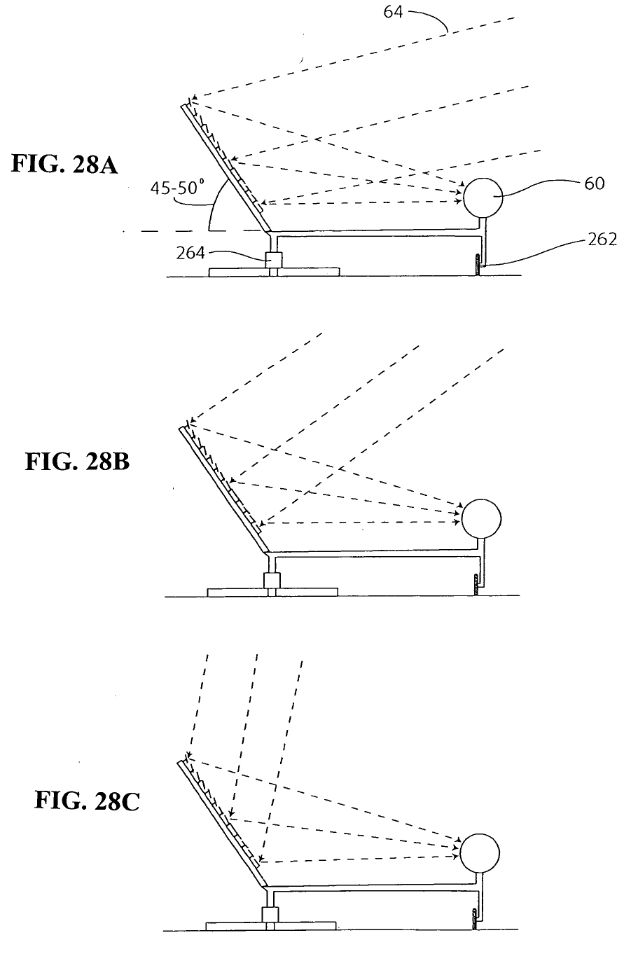

In the preferred embodiment of the solar roaster, this tracking row system is integrated into the roaster system as shown in FIG. 28. The mirror support fame remains at a fixed tilt angle, which should typically be between 45 and 50 degrees. The mirror array and the chosen solar roaster module embodiment (60) are connected to a support structure, which pivots horizontally about a large bearing or rotating support (264). A roaster system of the type shown in FIG. 28 adjusts its azimuth angle to track the sun by rolling about a semicircular path, riding on a motion-controlled motorized wheel (262). The system simultaneously tracks the zenith angle of the sun by adjusting the elevation of the mirror array's vertical rod (294) using a linear motor system. The linear motor (260) may be place on the front or back of the mirror array support structure, as shown in FIG. 26.

Both the zenith and azimuth tracking motors may be driven using one or two sensors placed on the main frame of the reflector array. The vertical tracking sensor may be placed on a special geared extension of one of the horizontal mirror rows. As the mirror row is tipped vertically, the vertical sensor tips in the same direction but with twice the magnitude of its angular rotation. This 2:1 gearing maintains the correct angle of the mirrors in the array, with respect to the elevation of the sun and elevation of the target.

Center Pivot Configurations

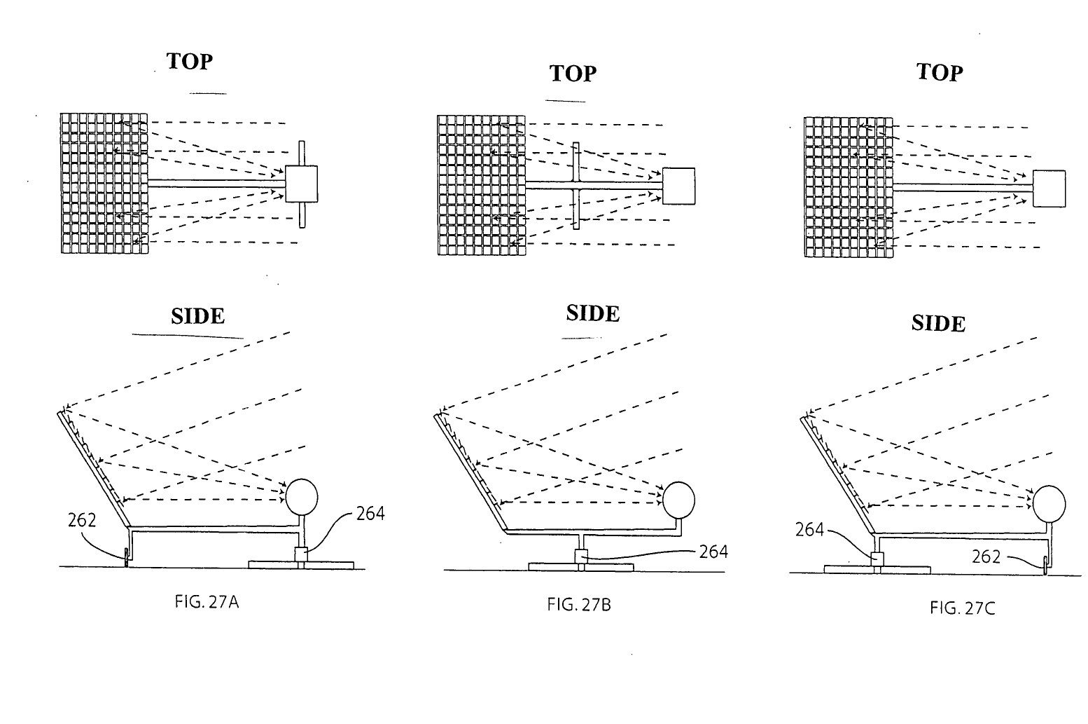

FIGS. 27A, 27B, and 27C illustrate three exemplary configurations of the center-pivot embodiment. FIG. 27A places the azimuth rotation point below the roaster module, and places drive motor wheels below the mirror array. This configuration is optimal for roasters of large size, or for use in harsh climates because it allows the roaster system to be nearly stationary throughout the day. It may additionally include an environmental enclosure or sun shade. FIG. 27B places the azimuth rotation point directly below the center of gravity of the mirror-roaster system. A low-speed motor may be incorporated directly into the pivot point. Because the system is entirely supported from one point, it does have some stability limitations when implemented at larger scales. The system may be ideal, however, for terrains that are too rough or are otherwise unsuitable for a flat semicircular path, as required for motorized wheels. FIG. 27C illustrates a center-pivoting embodiment that places the azimuth rotation point below the reflector system, and places the roaster module above a motorized wheel system. This configuration is best suited for situations of limited space, as it places the broad bulky mirror array at the center of rotation, making it less likely to interfere with nearby objects throughout the solar day.

C. Concentrator Embodiment #3: Power Tower

The power tower configuration of the solar roaster is intended for large-scale production of solar roasted coffees. Systems built with this configuration can be scaled to roast hundreds of pounds of coffee per load, and may be suitable for various continuous-roasting schemes as well. These roaster systems are best embodied through the use of the larger roaster versions of either the drum or fluid bed roaster modules, as described in section I. FIG. 24, for example, illustrates a power tower solar roaster that utilizes the large drum-type roasting module embodiment.

The defining. features of this system are as follows: 1) A mirror array (240) that comprises many separate mirrors that are capable of tracking the sun in two axes. Each mirror may be individually mounted on a tracking motor head, or motors may be clustered together in 2-axes tracking rows and columns in a system similar to the azimuth tracking scheme described in concentrator embodiment #2. 2) A high-temperature solar collector plate (24) that is raised on a tower, separated from the location of the roasting equipment. In operation, a circulating fan forces air up to and through the collector plate, where it is heated to in excess of 500 degrees. It is then passed down through an insulated duct and into the roaster system. The tower and roaster systems may be substantial structures, as neither need to pivot or move during the roasting process. As an extension, a single tower can be scaled so that the output of superheated air is sufficient to provide heat for multiple roaster modules. Multiple roaster systems provide the clear advantage of enabling higher volumes and/or simultaneous roasting of multiple different coffee types.

IV. Summary of an Exemplary Solar Roasting Process

The following description summarizes an exemplary procedure taken by a user (‘Roastmaster’) using a compact solar drum roaster with a two-pound capacity. The system uses the fixed mirror concentrator configuration, and is capable of providing 5 KW of solar power to the roaster module:

1. The decision is made to solar roast. Decision is based on observed and predicted weather conditions, and requires uninterrupted direct sunlight during the entire process.

2. The photovoltaic panel is checked to make sure it is optimally exposed to the sun, as an interruption in power reduces efficiency of the roasting process, and can even lead to an uneven roast.

3. The roaster module is checked, making sure the drum motor and blower fan are functioning. It is then tipped with the drum spinning and blower activated to remove any beans and chaff that may remain from a previous roast.

4. The mirror array system is uncovered and the mirrors are checked for debris or damage of any kind. The system should be stored so that the reflector faces north in the northern hemisphere, and south in the southern hemisphere.

5. With the roaster module in place on the main roaster arm, the sliding clamp is released, and the arm is lightly checked for balance within the rings of the “safety strut”.

6. Remove the ‘safety strut’ and Align the mirror array system to the sun using the alignment sundial, with the drum motor and the blower fan activated.

7. When the internal temperature reaches 400 degrees Fahrenheit, turn off blower fan, leaving drum motor running. Close the exhaust vent on the front of the roaster.

8. When the internal temperature reaches 550 degrees Fahrenheit, pour in 1 to 5 pounds of green coffee beans. The internal temperature will drop roughly 40 degrees. Adjust the drum speed controller to maintain the drum speed at roughly 25 rpm.

9. Maintain solar collector alignment for 18 to 20 minutes, making adjustments roughly every 5 minutes. Adjustments are made by releasing the sliding clamp, moving the main arm of the roaster, and then re-applying the clamp.

10. When a mixture of smoke and steam emerges from the roaster (roughly 18 to 20 minutes into the heating process) open the exhaust port and apply the blower fan for roughly 30 seconds.

11. With smoke and steam, the beans are very near “first pop” when the outer shells begin to crack off. It is characterized by a light snapping sound similar to the sound of dry tinder in a fire. When “first pop” occurs, check the beans using the “doser” to verify consistency of roast. If inconsistencies are detected, rapidly toggle the drum speed or momentarily reverse direction in order re-randomize tumbling.

12. “Second pop” should occur roughly two minutes after “first pop.” When it occurs, lower the roaster arm into the original position (reflectors facing north in northern hemisphere) and re-insert the “safety strut.” If a lighter roast is desired, this step should be performed after “first pop”, but before “second pop.”

13. Perform continuous checking of the beans during the last 30 to 50 seconds of roast. It is during this time that decisions about the final coffee are made.

14. Release the drum clamp and tip the roaster drum forward, pouring the beans into a receptacle. Squelch the roasting process by spraying the beans with water while stirring.

15. Vent the roaster drum for 5 minutes with the drum turning in order to remove chaff and stray beans. The roaster may then be raised and realigned with the sun (refer to step 6).

Note: If direct sunlight is lost at any point during the process, the roaster module will continue to roast coffee for some minutes because of retained heat. It is critical, however, that the drum motor does not stop rotating. Loss of drum rotation will result in the burning of beans that remain in direct contact with the internal drum. For this reason, the power supply system should be equipped with a battery-operation mode that may be activated in the event of clouds. With a suitable battery system, it has been shown that it is possible, though not desirable, to roast coffee during partly cloudy weather conditions.

Having described preferred embodiments for system and method for roasting coffee beans (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A system for roasting coffee beans comprising:
a solar receiving plate configured to receive and convert solar radiation to thermal energy for heating a volume of air;
a roasting chamber configured for receiving and circulating the heated air from the solar plate; and
at least one valve configured to be in at least one of a closed position and an open position for controlling at least one of air inflow and outflow into at least one of said solar receiving plate and said roasting chamber.

2. The system of claim 1, wherein said at least one valve comprises a first valve configured to control air intake to the receiver plate and a second valve configured to control air exhaust.

3. The system of claim 1, wherein said at least one valve comprises a single valve configured to control air intake and air exhaust.

4. The system of claim 1, wherein the roasting chamber includes a rotatable drum configured to receive the coffee beans.

5. The system of claim 1, wherein the roasting chamber comprises a fluid bed roaster chamber configured to receive and suspend the coffee beans during roasting.

6. The system of claim 1, wherein the solar plate includes a transparent window on an external surface of said solar plate.

7. The system of claim 2, further comprising a fan configured to direct airflow from the air intake valve to the solar plate.

8. The system of claim 2, wherein when said first and second valves are in a closed position, heated air exhaust from the drum is redirected back to the receiver plate.

9. The system of claim 4, wherein an inner surface of the solar plate is positioned directly adjacent to the roasting chamber, the system further comprising a scoop attached on an internal wall of the roasting chamber below the inner surface of the solar plate.

10. The system of claim 9, wherein the solar plate is recessed within an indentation surrounded by insulation of the roasting chamber.

11. The system of claim 8, further comprising a filtration apparatus configured to filter heated air being redirected back to the solar plate.

12. The system of claim 8, further including a return duct for redirecting the heated air from the drum back to the solar plate.

13. The system of claim 1, further comprising a solar thermal concentrator configured to collect and focus solar radiation onto the solar receiving plate.

14. The system of claim 13, wherein said solar concentrator includes:
a reflector having a plurality of mirrors in a fixed position; and
a reflector support frame configured to support and move the mirrors vertically and horizontally for tracking the sun's azimuth and zenith angles and focusing said solar radiation on the solar plate.

15. The system of claim 13, wherein said solar concentrator comprises:
a reflector comprised of a plurality of mirrors, wherein each row of said mirrors is attached to a separate support rod, each row of mirrors being configured to be independently movable for tracking zenith movements of the sun; and
an azimuth rotation point located below at least one of the roasting chamber, the reflector and the center of gravity of the roaster and solar concentrator system.

16. A method for roasting comprising the steps of:
providing a solar roasting system comprising a solar receiving plate configured to receive and convert solar radiation to thermal energy for heating a volume of air;
providing a roasting chamber configured for receiving and circulating the heated air from the solar plate;
providing at least one valve configured to be in at least one of a closed position and an open position for controlling at least one of air inflow and outflow into at least one of said solar receiving plate and said roasting chamber; and
providing a solar thermal concentrator configured to collect and focus solar radiation onto the solar receiving plate.

17. The method of claim 16, further comprising the steps of:
closing said at least one valve; and
redirecting the heated air output from the roasting chamber back to the solar plate.

18. The method of claim 16, wherein the step of providing at least one valve comprises providing a first valve configured to control air intake to the receiver plate and a second valve configured to control air exhaust.

19. The method of claim 18, further comprising the step of providing a return duct for connecting the second valve directly to the first valve, wherein when said first and second valves are closed, further comprising the step of redirecting the exhaust to the receiver plate via the return duct.

20. The method of claim 17, further comprising the step of providing a filter for filtering the redirected air from the roasting chamber to the solar plate.
